(19) United States
(12) Patent Application Publication
(10) Pub. No.: US 2023/0100788 A1
(43) Pub. Date: Mar. 30, 2023

(54) SERVER AND METHOD FOR PROVIDING RECOMMENDATION CONTENT

(71) Applicant: SAMSUNG ELECTRONICS CO., LTD., Suwon-si (KR)

(72) Inventors: Jacek Zatorski, Warsaw (PL); Piotr Bigaj, Warsaw (PL); Heuijin Lee, Suwon-si (KR); Jaroslaw Piotr Karciarz, Warsaw (PL); Rafal Paprocki, Warsaw (PL)

(73) Assignee: SAMSUNG ELECTRONICS CO., LTD., Suwon-si (KR)

(21) Appl. No.: 17/974,089

(22) Filed: Oct. 26, 2022

Related U.S. Application Data
(63) Continuation of application No. PCT/KR2022/014391, filed on Sep. 27, 2022.

(30) Foreign Application Priority Data
Sep. 27, 2021 (KR) 10-2021-0127552

(51) Int. Cl. G06Q 30/06; G06N 3/08

(52) U.S. Cl. CPC G06Q 30/0631; G06N 3/08

(57) ABSTRACT

Provided is a method of recommending content to a user where the method includes obtaining a feedback vector of the user for at least one of a plurality of pieces of content; obtaining feedback information for the plurality of pieces of content used by a plurality of users, generating user embedding vectors for the plurality of users and content embedding vectors for the plurality of pieces of content, determining a plurality of user groups and central users of the plurality of user groups by grouping the plurality of users, inputting user embedding vectors and the content embedding vectors to an artificial neural network model, obtaining preference vectors of the central users for the plurality of pieces of content, the preference vectors being output by the artificial neural network model, determining at least one piece of recommendation content and recommending the at least one piece of recommendation content to the user.

### CROSS-REFERENCE TO RELATED APPLICATION(S)

This application is a bypass continuation of International Application No. PCT/KR2022/014391 filed on Sep. 27, 2022, which is based on and claims priority to Korean Patent Application No. 10-2021-0127552 filed on Sep. 27, 2021, in the Korean Intellectual Property Office, the disclosures of which are incorporated by reference herein in their entireties.

### BACKGROUND

### Field

The disclosure relates to a server and method for providing recommendation content, and more particularly, to a server and method for providing recommendation content based on central users of a plurality of user groups determined by grouping a plurality of users.

### Description of the Related Art

Recently, through various Internet environments, users are able to use streaming services of various types of multimedia content including movies, music, and the like, and purchase various products through the Internet. To enable the users to use the streaming services of appropriate multimedia content, download an application, or purchase a desired product, various techniques have been developed to provide the users, with customized recommended content, a recommended application, or a recommended product.

General user-customized content providing techniques include a collaborative filtering technique of speculating on content that may be preferred by a user based on user information and selecting and providing an appropriate specific item to the user and a content-based filtering technique of recommending similar content to a user based on content history information used by the user.

However, due to the introduction of the 5^{th} generation (5G) communication environment, a large increase in the number of pieces of various content in the Internet environment, and the occurrence of a case in which content history information used by a user is insufficient, it may be difficult to provide appropriate recommendation content to the user. Also, various types of content in the Internet environment are generated, and thus a storage space may be insufficient or it may take a long time to provide the appropriate recommendation content to the user. Accordingly, there is a need for a technology for providing the appropriate recommendation content to the user while providing recommendation content to the user within an appropriate time.

An embodiment of the disclosure is to provide recommendation content to a user based on central users of a plurality of user groups determined by grouping a plurality of users, so as to provide appropriate recommendation content to the user while providing recommendation content to the user within an appropriate time.

### SUMMARY

According to an embodiment of the disclosure, a method of recommending content to a user may include based on a content recommendation request received from a device of the user. A Method may include obtaining a feedback vector of the user for at least one of a plurality of pieces of content. A Method may include obtaining feedback information for the plurality of pieces of content used by a plurality of users. A Method may include generating user embedding vectors for the plurality of users and content embedding vectors for the plurality of pieces of content, based on the feedback information. A Method may include determining a plurality of user groups and central users of the plurality of user groups by grouping the plurality of users based on the user embedding vectors for the plurality of users. A Method may include inputting user embedding vectors for the central users and the content embedding vectors for the plurality of pieces of content to an artificial neural network model configured to estimate a preference degree for content. A Method may include obtaining preference vectors of the central users, which indicate estimated preference degrees of the central users for the plurality of pieces of content, the preference vectors being output by the artificial neural network model. A Method may include determining at least one piece of recommendation content to be recommended to the user, based on the feedback vector of the user and the preference vectors of the central users. A Method may include recommending the determined at least one piece of recommendation content to the user.

According to an embodiment of the disclosure, a server for recommending content to a user includes a communication interface, a memory storing one or more instructions and a processor configured to execute the one or more instructions. The processor may be configure to, based on a content recommendation request received from a device of the user, obtain a feedback vector of the user for at least one of a plurality of pieces of content. The processor may be configure to obtain feedback information for the plurality of pieces of content used by a plurality of users. The processor may be configure to generate user embedding vectors for the plurality of users and content embedding vectors for the plurality of pieces of content, based on the feedback information, The processor may be configure to determine a plurality of user groups and central users of the plurality of user groups by grouping the plurality of users based on the user embedding vectors for the plurality of users. The processor may be configure to input the user embedding vectors for the central users and the content embedding vectors for the plurality of pieces of content to an artificial neural network model configured to estimate a preference degree of the user for content. The processor may be configure to obtain preference vectors of the central users, which indicate estimated preference degrees of the central users for the plurality of pieces of content, the preference vectors being output by the artificial neural network model. The processor may be configure to determine at least one piece of recommendation content to be recommended to the user, based on the feedback vector of the user and the preference vectors of the central users. The processor may be configure to recommend the determined at least one piece recommendation content to the user.

According to an embodiment, a non-transitory computer-readable storage medium, having a computer program for learning universal vector representation of concepts in a distributed environment, which implemented on at least one processor, is provided. The processor may be configure to, based on a content recommendation request received from a device of the user, obtain a feedback vector of the user for at least one of a plurality of pieces of content. The processor may be configure to obtain feedback information for the plurality of pieces of content used by a plurality of users. The processor may be configure to generate user embedding vectors for the plurality of users and content embedding vectors for the plurality of pieces of content, based on the feedback information, The processor may be configure to determine a plurality of user groups and central users of the plurality of user groups by grouping the plurality of users based on the user embedding vectors for the plurality of users. The processor may be configure to input the user embedding vectors for the central users and the content embedding vectors for the plurality of pieces of content to an artificial neural network model configured to estimate a preference degree of the user for content. The processor may be configure to obtain preference vectors of the central users, which indicate estimated preference degrees of the central users for the plurality of pieces of content, the preference vectors being output by the artificial neural network model. The processor may be configure to determine at least one piece of recommendation content to be recommended to the user, based on the feedback vector of the user and the preference vectors of the central users. The processor may be configure to recommend the determined at least one piece recommendation content to the user.

### BRIEF DESCRIPTION OF THE DRAWINGS

FIG. 1 is a diagram for describing a method of recommending content to a user, according to an embodiment of the disclosure.

FIG. 2 is a flowchart of a method of providing recommendation content to a user, according to an embodiment of the disclosure.

FIG. 3 is a diagram showing an example of feedback information obtained from a plurality of users, according to an embodiment of the disclosure.

FIG. 4 is a diagram showing an example of user embedding vectors for a plurality of users and content embedding vectors for a plurality of pieces of content, which are generated based on feedback information, according to an embodiment of the disclosure.

FIG. 5 is a diagram showing a user embedding vector of a first user and a user embedding vector of a second user of FIG. 4, according to an embodiment of the disclosure.

FIG. 6 is a flowchart of a method of determining a plurality of user groups and central users of the plurality of user groups, according to an embodiment of the disclosure.

FIG. 7 is a diagram showing an example of determining central users of a plurality of user groups by grouping a plurality of users, according to an embodiment of the disclosure.

FIG. 8 is a diagram showing an example of determining central users of a plurality of user groups, in an embedding space, according to an embodiment of the disclosure.

FIG. 9 is a diagram showing an example of training an artificial neural network model, according to an embodiment of the disclosure.

FIG. 10 is a diagram for describing an artificial neural network model, according to an embodiment of the disclosure.

FIG. 11 is a flowchart of a method of determining at least one piece of recommendation content to be recommended to a user, according to an embodiment of the disclosure.

FIG. 12 is a diagram showing an example of at least one piece of recommendation content to be recommended to a user, according to an embodiment of the disclosure.

FIG. 13 is a diagram showing an example of at least one piece of recommendation content to be recommended to a user, based on difference values of central users, according to an embodiment of the disclosure.

FIG. 14 is a diagram of a required time until recommendation content is provided to a user and a difference value of content preference degree estimation, according to the number of a plurality of user groups, according to an embodiment of the disclosure.

FIG. 15 is a flowchart of a method of adjusting the number of a plurality of user groups and regrouping a user and a plurality of users, based on the adjusted number of the plurality of user groups, according to an embodiment of the disclosure.

FIG. 16 is a flowchart of a method of determining whether to adjust the number of a plurality of user groups based on a similarity value of a selected central user, and when it is determined to adjust the number of the plurality of user groups, regrouping a plurality of users and a user according to the adjusted number of the plurality of user groups, according to an embodiment of the disclosure.

FIG. 17 is a diagram showing an example of regrouping a plurality of users and a user to the adjusted number of the plurality of user groups when the number of the plurality of user groups is decreased in FIG. 16, according to an embodiment of the disclosure.

FIG. 18 is a diagram showing an example of, regrouping a plurality of users and a user when the number of the plurality of user groups is maintained in FIG. 16, according to an embodiment of the disclosure.

FIG. 19 is a diagram showing an example of regrouping a plurality of users and a user to the adjusted number of the plurality of user groups when the number of the plurality of user groups is increased in FIG. 16, according to an embodiment of the disclosure.

FIG. 20 is a flowchart of a method of determining whether to adjust the number of a plurality of user groups based on Euclidean distances between user embedding vectors for at least one user belonging to each of the plurality of user groups, and when it is determined to adjust the number of the plurality of user groups, regrouping a plurality of users and a user to the adjusted number of the plurality of user groups, according to an embodiment of the disclosure.

FIG. 21 is a block diagram of a server according to an embodiment of the disclosure.

### DETAILED DESCRIPTION

Throughout the disclosure, the expression “at least one of a, b or c” indicates only a, only b, only c, both a and b, both a and c, both b and c, all of a, b, and c, or variations thereof.

Hereinafter, embodiments of the disclosure will be described in detail with reference to the accompanying drawings such that one of ordinary skill in the art may easily implement the disclosure. However, the disclosure may be implemented in various different forms and is not limited to the embodiments of the disclosure described herein. Also, in the drawings, parts irrelevant to the description are omitted in order to clearly describe the disclosure, and like reference numerals designate like elements throughout the specification.

Throughout the specification, when a part is “connected” to another part, the part may not only be “directly connected” to the other part, but may also be “electrically connected” to the other part with another element in between. In addition, when a part “includes” a certain element, the part may further include another element instead of excluding the other element, unless otherwise stated.

The terms used in the disclosure will be briefly defined, and embodiments of the disclosure will be described in detail.

In the present specification, content may include multimedia content including movies, music, and the like, and content including various products purchasable from the Internet or an application downloadable from an application store. According to an embodiment of the disclosure, customized content may be recommended to a user. For example, applications exposed on a first screen when accessing the application store may be pieces of customized recommendation content (or customized recommended applications) provided to the user. Also, pieces of music exposed at the top when a recommendation button of a player for listening to music is clicked may be pieces of customized recommendation content (or pieces of customized recommended music) provided to the user.

Also, a feedback vector may be a vector indicating a preference degree of a user for at least one of a plurality of pieces of content, i.e., the vector indicating the user's preference degree regarding the at least one of the plurality of pieces of content. The preference degree of the user for at least one of the plurality of pieces of content may include “positive”, “negative”, or “no preference”, and an element value of the feedback vector corresponding to “positive”, “negative”, or “no preference” may be obtained. For example, when a preference degree of the user for content is positive, the preference degree may correspond to 1 that is an element value of a feedback vector, when the preference degree of the user for the content is negative, the preference degree may correspond to 0 that is the element value of the feedback vector, and when the preference degree of the user for the content is no preference, the preference degree may correspond to a blank of an element of the feedback vector. Also, for example, the preference degree of the user for at least one of the plurality of pieces of content may only include “positive” or “negative”, and when the preference degree of the user is “no preference”, the preference degree may be determined to correspond to one of “positive” and “negative”.

The preference degree may be determined based on a behavior, action, or reaction of the user for at least one of the plurality of pieces of content. For example, when the user clicks content or looks at the content at least for a certain period of time, a preference degree of the user for the content may be determined to be positive. On the other hand, when the user scrolls the content or scores a certain score or lower for the content, the preference degree of the user for the content may be determined to be negative. In the present specification, feedback information may include a plurality of feedback vectors indicating preference degrees of a plurality of users for a plurality of pieces of content, and for example, may include a matrix including the plurality of feedback vectors.

An embedding vector may be a vector indicating a natural language used by a person in a form of numbers that may be interpreted by a computer. In the present specification, the embedding vector may be a latent vector or a latent factor, and may indicate only mathematical values.

A user embedding vector may be an embedding vector generated to distinguish a user, based on preference degrees of a plurality of users for a plurality of pieces of content, and a content embedding vector may be an embedding vector generated for content to distinguish the content, based on preference degrees of a plurality of users for a plurality of pieces of content. For example, user embedding vectors and content embedding vectors may be generated such that multiplication of a matrix of the user embedding vectors and a matrix of the content embedding vectors is similar to a matrix including feedback vectors of users for pieces of content.

In the present specification, it may be determined that preference degrees of a plurality of users for a plurality of pieces of content are similar when a Euclidean distance between user embedding vectors is close. For example, when a user embedding vector of a first user is closer to a user embedding vector of a third user than to a user embedding vector of a second user, it may be determined that preference degrees of the first user and the third user for a plurality of pieces of content are similar.

A dimension of an embedding vector may be determined in consideration of a memory of a server, a required time until recommendation content is provided, and the like, and may be stored in the server after being pre-set. For example, when a size of the memory of the server increases, the dimension of the embedding vector may also increase. Also, in the present specification, the embedding vector may include a plurality of user embedding vectors for a plurality of users, and a plurality of content embedding vectors for a plurality of pieces of content, and the plurality of user embedding vectors and the plurality of content embedding vectors may be determined based on feedback information.

Hereinafter, the disclosure will be described in detail with reference to accompanying drawings.

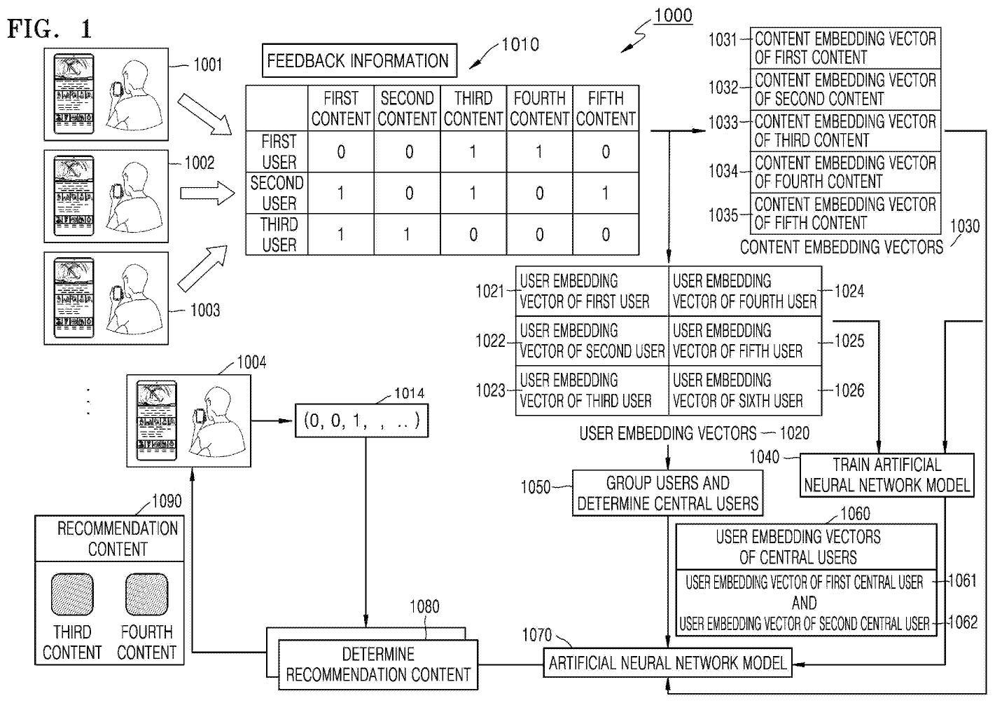

FIG. 1 is a diagram for describing a method of recommending content to a user, according to an embodiment of the disclosure.

Referring to FIG. 1, a server 1000 may communicate with a plurality of users (for example, a first user 1001, a second user 1002, and a third user 1003). The server 1000 may obtain behaviors, actions, and reactions of the plurality of users for at least one of a plurality of pieces of content. For example, a device (for example, a portable terminal) of the first user 1001 may obtain a behavior, action, or reaction of the first user 1001 for at least one of the plurality of pieces of content, and the behavior or the like of the first user 1001 for at least one of the plurality of pieces of content may be uploaded in or transmitted to the server 1000 from the device of the first user 1001, through a communication interface of the device of the first user 1001. In FIG. 1, the first user 1001, the second user 1002, and the third user 1003 from among the plurality of users are illustrated, but the plurality of users are not limited thereto.

The server 1000 may obtain feedback information 1010, based on the obtained behaviors or the like of the plurality of users for at least one of the plurality of pieces of content. For example, the feedback information 1010 may be in a form of table or matrix indicating preference degrees of the plurality of users for the plurality of pieces of content, and a value corresponding to an m^{th} row and an n^{th} column of the table may correspond to a preference degree of an m^{th} user for n^{th} content. Also, the feedback information 1010 may be obtained based on behaviors or the like of the plurality of users for some pieces of content, and the value corresponding to the m^{th} row and the n^{th} column of the table may be blank. The blank may denote that there is no data about a behavior or reaction of the m^{th} user for the n^{th} content.

The server 1000 may generate, based on the feedback information 1010, user embedding vectors 1020 of the plurality of users and content embedding vectors 1030 of the plurality of pieces of content. The user embedding vectors 1020 may include a user embedding vector 1021 of the first user 1001, a user embedding vector 1022 of the second user 1002, a user embedding vector 1023 of the third user 1003, a user embedding vector 1024 of a fourth user (not shown), a user embedding vector 1025 of a fifth user (not shown), and a user embedding vector 1026 of a sixth user (not shown), but are not limited thereto. The content embedding vectors 1030 may include a content embedding vector 1031 of first content, a content embedding vector 1032 of second content, a content embedding vector 1033 of third content, a content embedding vector 1034 of fourth content, and a content embedding vector 1035 of fifth content, but are not limited thereto.

Also, the server 1000 may train an artificial neural network model based on the user embedding vectors 1020 of the plurality of users and the content embedding vectors 1030 of the plurality of pieces of content in operation 1040. The artificial neural network model 1070 may be used to estimate a preference degree of a user for content.

Also, the server 1000 may group the plurality of users and determine central users of a plurality of user groups based on the user embedding vectors 1020, in operation 1050. When a Euclidean distance between the user embedding vectors 1020 is close, preference degrees of the plurality of users for the plurality of pieces of content are similar, and thus it may be estimated that preference degrees of at least one user in the plurality of user groups for the plurality of pieces of content are similar. Also, the central users of the plurality of user groups may be users representing the preference degrees of the at least one user in the plurality of user groups for the plurality of pieces of content. For example, user embedding vectors 1060 of the central users may include a user embedding vector 1061 of a first central user and a user embedding vector 1062 of a second central user.

The server 1000 may determine recommendation content by using a pre-trained artificial neural network model 1070, based on the user embedding vectors 1060 of the central users and the content embedding vectors 1030 in operation 1080. In detail, preference vectors indicating estimated preference degrees of the central users (for example, the first user 1001 and the second user 1002) for the plurality of pieces of content may be generated based on the user embedding vectors 1060 of the central users and the content embedding vectors 1030. Recommendation content 1090 may be provided to a user 1004, based on the generated preference vectors and a feedback vector 1014 of the user 1004 of a device that requested to recommend content. For example, when it is determined that preference degrees of the first user 1001 among the central users and the user 1004 for the plurality of pieces of content are similar, the recommendation content 1090 including the third content and the fourth content preferred by the first user 1001 may be provided.

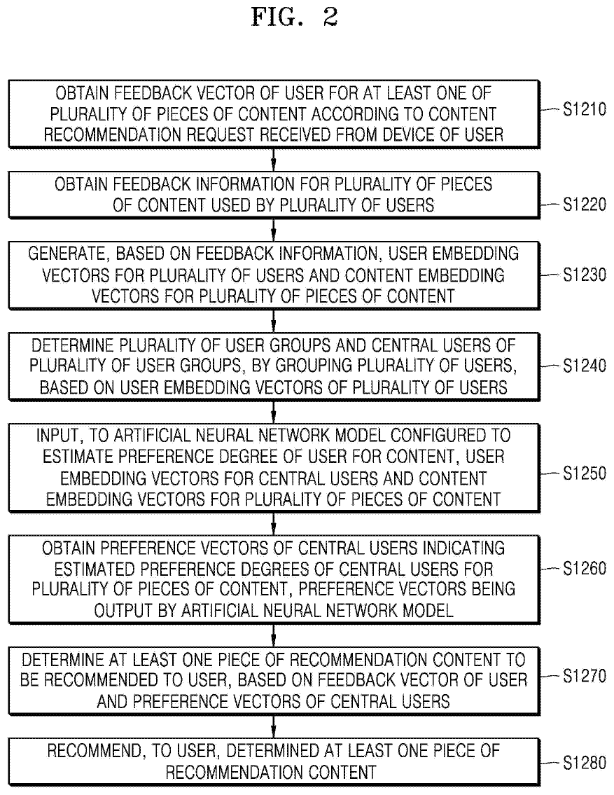

FIG. 2 is a flowchart of a method of providing recommendation content to a user, according to an embodiment of the disclosure.

In operation 1210, a server may obtain a feedback vector of a user for at least one of a plurality of pieces of content, according to a content recommendation request received from a device of the user.

According to an embodiment of the disclosure, the device of the user may transmit the content recommendation request to the server 1000. The user may be the user 1004 of FIG. 1. In detail, a device of the user 1004 may transmit the content recommendation request to the server 1000 according to a pre-set cycle or to the server 1000 through a communication interface of the device, based on a user input. For example, the device of the user 1004 may transmit the content recommendation request to the server 1000 by identifying, as the user input, the user 1004 accessing a site for content recommendation, an application store for downloading an application, or a multimedia content streaming site.

According to an embodiment, of the disclosure, the device of the user may obtain the feedback vector of the user for at least one of the plurality of pieces of content according to the content recommendation request received from the device of the user. For example, the feedback vector may be a vector (for example, the feedback vector 1014 of the user 1004) indicating a preference degree of the user for at least one of the plurality of pieces of content, and a value of the corresponding feedback vector may vary according to a preference degree of the user for content. For example, when the user 1004 prefers first content (for example, when there is a history of the user 1004 clicking the first content), a value of a first element of the feedback vector may be 1. Also, for example, when the user 1004 does not prefer second content (for example, when there is a history of the user 1004 scrolling the second content), a value of a second element of the feedback vector may be 0. For example, when there is no reaction or behavior of the user 1004 for third content, a value of a third element of the feedback vector may be blank. A value of an element of the feedback vector may be 1, blank, or 0 or may be 1, 0, or −1, depending on preference degrees of the user for the plurality of pieces of content, but is not limited thereto. The feedback vector of the user for at least one of the plurality of pieces of content may be pre-generated and stored in the device of the user. The feedback vector of the user for at least one of the plurality of pieces of content may be generated based on data about the preference degrees of the plurality of users for the plurality of pieces of content, according to a request of the user.

In operation 1220, the server may obtain feedback information for the plurality of pieces of content used by the plurality of users.

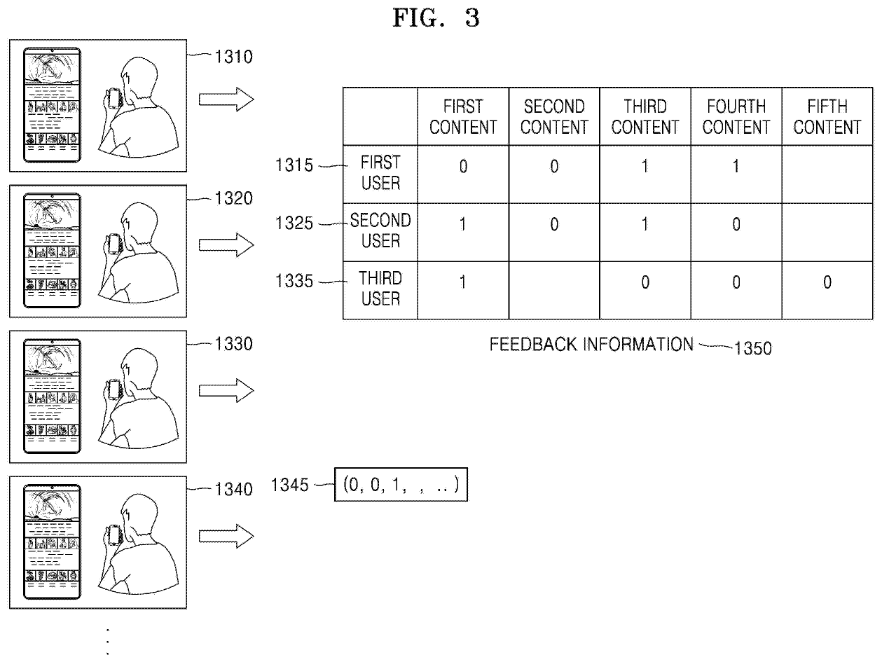

According to an embodiment of the disclosure, the server may obtain the feedback information indicating the preference degrees of the plurality of users for the plurality of pieces of content. In detail, the feedback information may include a plurality of feedback vectors indicating the preference degrees of the plurality of users for the plurality of pieces of content. For example, the feedback information may be a set of the plurality of feedback vectors, and in a form of matrix including the feedback vectors. The feedback information of the disclosure will be described in more detail with reference to FIG. 3.

In operation 1230, the server may generate user embedding vectors for the plurality of users and content embedding vectors for the plurality of pieces of content based on the feedback information.

According to an embodiment of the disclosure, the user embedding vector may be an embedding vector generated to distinguish the user, based on the preference degrees of the plurality of users for the plurality of pieces of content, and the content embedding vector may be an embedding vector generated for content to distinguish the content, based on the preference degrees of the plurality of users for the plurality of pieces of content.

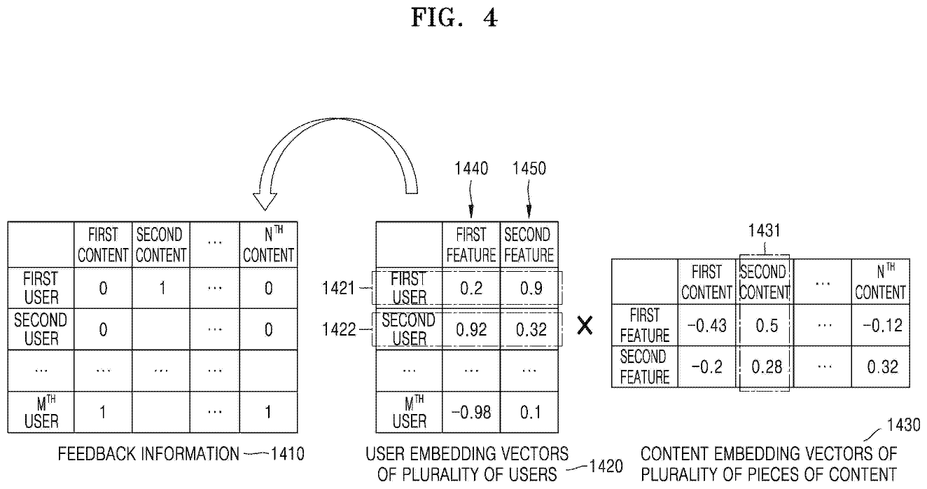

According to an embodiment of the disclosure, embedding vectors (including the user embedding vectors for the plurality of users and the content embedding vectors for the plurality of pieces of content) may be generated in any one of various methods, based on the feedback information. In detail, the server 1000 may generate the user embedding vectors for the plurality of users and the content embedding vectors for the plurality of pieces of content, through matrix factorization, training of an artificial neural network model including a specific architecture, or an embedding vector generation method based on one-hot encoding, but an embodiment of the disclosure is not limited thereto. For example, the user embedding vectors for the plurality of users and the content embedding vectors for the plurality of pieces of content, which include the feedback information and errors equal to or less than a pre-set first threshold value, may be generated according to the matrix factorization. A method of generating the user embedding vectors for the plurality of users and the content embedding vectors for the plurality of pieces of content will be described in detail with reference to FIG. 4.

In operation 1240, the server may determine a plurality of user groups and central users of the plurality of user groups by grouping the plurality of users based on the user embedding vectors for the plurality of users.

According to an embodiment of the disclosure, the server may determine the plurality of user groups by grouping the plurality of users, based on the user embedding vectors for the plurality of users. The number of the plurality of user groups may be stored in the server or may be pre-set. In detail, the server 1000 may determine the plurality of user groups based on Euclidean distances between the user embedding vectors for the plurality of users. For example, the server 1000 may group the plurality of users into a pre-set number of the plurality of user groups, based on k-mean clustering.

According to an embodiment of the disclosure, the server may determine the central users of the plurality of user groups based on the user embedding vectors for the plurality of users. In detail, the central users of the plurality of user groups may be determined based on Euclidean distances between user embedding vectors for at least one user belonging to each of the determined plurality of user groups. For example, centroids of the plurality of user groups may be calculated based on the Euclidean distances between the user embedding vectors for the at least one user belonging to each of the determined plurality of user groups, and users closest to the calculated centroids may be determined as the central users of the plurality of user groups. Also, the central user of each of the plurality of user groups may be a user belonging to each of the plurality of user groups, the user having a smallest Euclidean distance sum with at least one user belonging to each of the plurality of user groups.

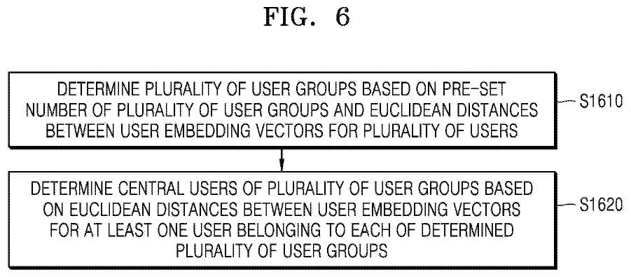

According to an embodiment of the disclosure, the server 1000 may estimate that preference degrees of users for content may be similar when a distance between user embedding vectors is close, in an embedding space including the user embedding vectors for the plurality of users. For example, the server 1000 may estimate that the central users of the plurality of user groups may have similar preference degrees as the plurality of user groups for content, and the central users of the plurality of user groups may be users representing the plurality of user groups. Accordingly, even when the user embedding vectors of the central users, instead of all the user embedding vectors for the plurality of users, are input to an artificial neural network model configured to estimate a preference degree of a user for content, appropriate customized content may be provided to the user quickly. A method of determining the central users of the plurality of user groups by grouping the plurality of users will be described in detail with reference to FIGS. 6 through 8.

In operation S1250, the server may input the user embedding vectors for the central users and the content embedding vectors for the plurality of pieces of content to the artificial neural network model configured to estimate a preference degree of a user for content.

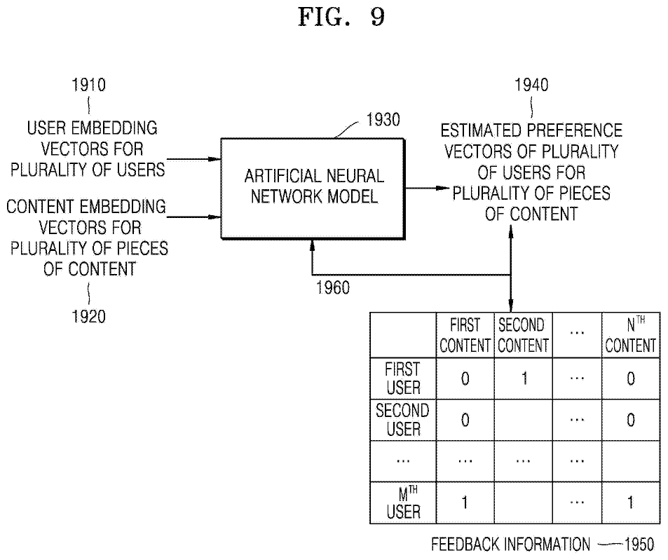

According to an embodiment of the disclosure, the server 1000 may input, to the artificial neural network model configured to estimate a preference degree of a user for content, the user embedding vectors for the central users and the content embedding vectors for the plurality of pieces of content. However, the artificial neural network model may be trained based on the user embedding vectors for the plurality of users and the content embedding vectors for the plurality of pieces of content. A method of training the artificial neural network model configured to estimate a preference degree of the user for content will be described in detail with reference to FIG. 9.

In operation S1260, the server may obtain preference vectors of the central users, which indicate estimated preference degrees of the central users for the plurality of pieces of content, the preference vectors being output by the artificial neural network model.

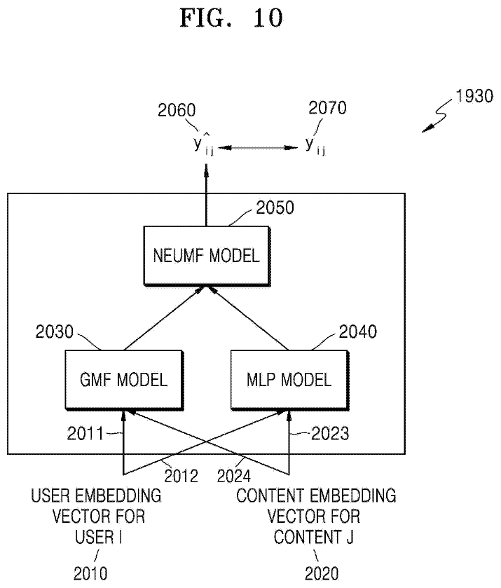

According to an embodiment of the disclosure, the server 1000 may obtain the preference vectors of the central users indicating the estimated preference degrees of the central users for the plurality of pieces of content. In detail, a user embedding vector of an m^{th} central user and a content embedding vector of n^{th} content may be input to the artificial neural network model, and the artificial neural network model may output a value of an estimated preference degree of the m^{th} central user for the n^{th} content. For example, the value of the estimated preference degree of the m^{th} central user for the n^{th} content may be a value of an n^{th} element of a preference vector of the m^{th} central user. Also, values of the estimated preference degrees of the central users for the plurality of pieces of content may be output in real values between 0 and 1. For example, when a value of a first element of a first central user is 0.9 and a value of a second element thereof is 0.2, it may be expected that it is highly likely for the first central user to prefer first content than second content. The real number is not limited to between 0 and 1. A method of obtaining the preference vectors of the central users indicating the estimated preference degrees of the central users for the plurality of pieces of content will be described in detail with reference to FIG. 10.

In operation S1270, the server may determine at least one piece of recommendation content to be recommended to the user, based on the feedback vector of the user and the preference vectors of the central users.

According to an embodiment of the disclosure, the server 1000 may select a central user to be used to recommend content based on the feedback vector of the user and the preference vectors of the central users. In detail, for example, the feedback vector of the user 1004 and the preference vectors of the central users may be compared to select a central user having a most similar preference degree as the user 1004 for content. For example, in FIG. 1, the server 1000 may compare the feedback vector 1014 of the user 1004 with preference vectors of the central users, and determine, as the selected central user from among the central users, the first user 1001 having the same preference degree as the user 1004 for the first through third content.

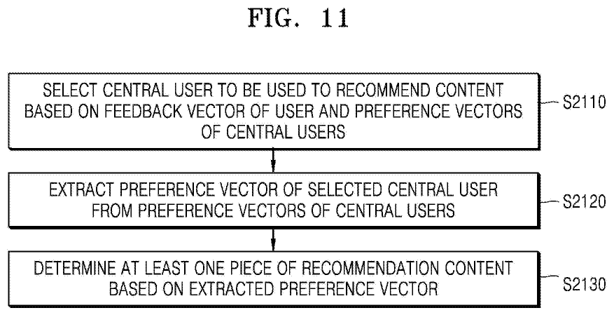

According to an embodiment of the disclosure, the server 1000 may extract the preference vector of the selected central user from the preference vectors of the central users, and determine the at least one piece of recommendation content based on the extracted preference vector. For example, when the number of pieces of content to be recommended to the user is pre-set, the pre-set number of pieces of recommendation content may be provided to the user, based on a value of an element of the extracted preference vector of the central user. When there are a plurality of pieces of content to be recommended, the server 1000 may determine a recommendation content list to be provided to the user 1004. For example, in FIG. 1, the recommendation content list may include the third content and the fourth content. A method of determining the at least one piece of recommendation content to be recommended to the user will be described in detail with reference to FIGS. 11 through 13.

In operation S1280, the server may recommend the determined at least one piece of recommendation content to the user.

For example, in FIG. 1, the server 1000 may provide, to the user 1004, the recommendation content 1090 including the third content and the fourth content. The number of pieces of at least one recommendation content to be recommended may be pre-stored.

FIG. 3 is a diagram showing an example of feedback information 1350 obtained from a plurality of users, according to an embodiment of the disclosure.

According to an embodiment of the disclosure, referring to FIG. 3, a server (may be the server 1000 of FIG. 1) may obtain behaviors, actions, and reactions of the plurality of users for at least one of a plurality of pieces of content. In detail, the behaviors, actions, and reactions of the plurality of users for at least one of the plurality of pieces of content may be obtained through devices of the plurality of users, and the behaviors or the like of the plurality of users for at least one of the plurality of pieces of content may be uploaded or transmitted to the server from the devices of the plurality of users, through communication interfaces of the devices of the plurality of users. In FIG. 3, a first user 1310, a second user 1320, a third user 1330, and a user 1340 from among the plurality of users are illustrated, but the plurality of users are not limited thereto.

According to an embodiment of the disclosure, a feedback vector of a user may be a vector indicating a preference degree of the user for at least one of a plurality of pieces of content. In detail, the preference degree of the user for at least one of the plurality of pieces of content may be determined based on a behavior or reaction of the user for the at least one of the plurality of pieces of content, and the preference degrees of the user for the plurality of pieces of content may be classified as “positive” or “negative”, or “positive”, “negative”, or “no preference”, but are not limited thereto. For example, the preference degrees of the user for the plurality of pieces of content may be classified as “positive” or “negative”, or “positive”, “negative”, or “no preference”, based on behaviors of the user clicking the plurality of pieces of content, scrolling the plurality of pieces of content, looking at the plurality of pieces of content for at least a certain period of time, scoring the plurality of pieces of content, downloading the plurality of pieces of content, streaming the plurality of pieces of content for at least a certain period of time, or watching previews of the plurality of pieces of content. Also, for example, a method of classifying the preference degrees of the user for the plurality of pieces of content as “positive” or “negative”, or “positive”, “negative”, or “no preference” may be stored in the server after being changed or pre-set by a processor of the server.

According to an embodiment of the disclosure, element values of the feedback vector of the user may vary depending on the preference degrees of the user for the plurality of pieces of content. For example, when a preference degree of the user for content is “positive”, an element value of the feedback vector of the user may be 1, when the preference degree of the user for the content is “negative”, the element value of the feedback vector of the user may be 0, and when there is no history of the preference degree of the user for the content, the element value of the feedback vector of the user may be blank. For example, when the preference degree of the user for the content is “positive”, the element value of the feedback vector of the user may be 1, when the preference degree of the user for the content is “negative”, the element value of the feedback vector of the user may be −1, and when there is no history of the preference degree of the user for the content, the element value of the feedback vector of the user may be blank, i.e., 0. For example, a feedback vector 1345 of the user 1340 to whom customized content is to be provided may be (0,0,1, ,).

According to an embodiment of the disclosure, the server may obtain the feedback information 1350, based on the obtained behaviors or the like of the plurality of users for at least one of the plurality of pieces of content. In detail, referring to FIG. 3, the feedback information 1350 may include a feedback vector 1315 of the first user 1310, a feedback vector 1325 of the second user 1320, and a feedback vector 1335 of the third user 1330. For example, the first user 1310 has scrolled first content and second content, and thus values of first and second elements of the feedback vector 1315 may be 0. Also, for example, the first user 1310 has clicked third content and fourth content, and thus values of third and fourth elements of the feedback vector 1315 may be 1. Also, for example, there is no behavior history of the first user 1310 for fifth content, and thus a value of a fifth element of the feedback vector 1315 may be blank.

According to an embodiment of the disclosure, the feedback information 1350 may be feedback information generated based on data related to the behaviors or the like of the plurality of users for the plurality of pieces of content, before a content recommendation request is received from a device of the user 1340. Alternatively, the feedback information 1350 may be feedback information generated based on latest data related to the behaviors or the like of the plurality of users for the plurality of pieces of content, after the content recommendation request is received from the device of the user 1340.

FIG. 4 is a diagram showing an example of user embedding vectors 1420 for a plurality of users and content embedding vectors 1430 for a plurality of pieces of content, which are generated based on feedback information 1410, according to an embodiment of the disclosure.

According to an embodiment of the disclosure, a user embedding vector may be an embedding vector generated to distinguish a user, based on preference degrees of a plurality of users for a plurality of pieces of content, and a content embedding vector may be an embedding vector generated for content to distinguish the content, based on the preference degrees of the plurality of users for the plurality of pieces of content.

According to an embodiment of the disclosure, embedding vectors (including the user embedding vectors 1420 for the plurality of users and the content embedding vectors 1430 for the plurality of pieces of content) may be generated by using any one of various methods, based on the feedback information 1410.

For example, as shown in FIG. 4, the user embedding vectors 1420 for the plurality of users and the content embedding vectors 1430 for the plurality of pieces of content, which include the feedback information 1410 and errors equal to or less than a pre-set first threshold value, may be generated according to matrix factorization. The user embedding vectors 1420 for the plurality of users may include a user embedding vector 1421 of a first user and a user embedding vector 1422 of a second user, and the content embedding vectors 1430 for the plurality of pieces of content may include a content embedding vector 1431 of second content.

According to an embodiment of the disclosure, the user embedding vectors 1420 for the plurality of users and the content embedding vectors 1430 for the plurality of pieces of content may be generated such that Equation 1 below is satisfied.

$${min}_{p , q} \{ {\sum }_{( i , u ) ∈ k} {( {r}_{ui} - {p}_{u}^{T} {q}_{i} )}^{2} + γ ( {‖ {p}_{u} ‖}^{2} + {‖ {q}_{i} ‖}^{2} ) \} \qquad [ Equation 1 ]$$

rᵤᵢ in Equation 1 denotes a value of an element indicating a preference degree of a user u for content i in feedback information 1410. pᵤ may denote a user embedding vector of a user u and qᵢ may denote a content embedding vector of content i. r may be pre-set value, u may be an integer between 1 to M, and i may be an integer between 1 and N.

According to an embodiment of the disclosure, a dimension of an embedding vector may be determined in consideration of a memory of a server, a required time until recommendation content is provided, and the like, and may be pre-set and stored in the server. A first feature 1440 and a second feature 1450 may be axes of the user embedding vectors 1420 for the plurality of users and the content embedding vectors 1430 for the plurality of pieces of content.

As embedding vectors of the present specification, user embedding vectors 1420 for a plurality of users and content embedding vectors 1430 for a plurality of pieces of content may be generated through matrix factorization, training of an artificial neural network model including a specific architecture, or an embedding vector generation method based on one-hot encoding, but the embedding vectors are not limited thereto.

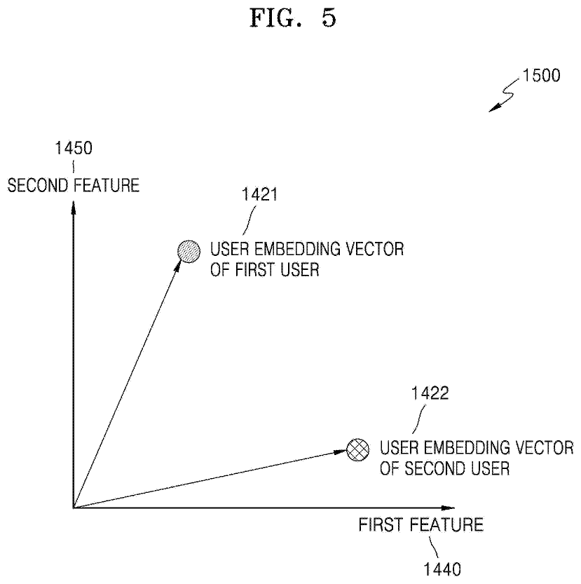

FIG. 5 is a diagram showing the user embedding vector 1421 of the first user and the user embedding vector 1422 of the second user of FIG. 4, according to an embodiment of the disclosure.

According to an embodiment of the disclosure, a graph 1500 illustrates the user embedding vector 1421 of the first user and the user embedding vector 1422 of the second user. As shown in FIG. 4, an x-axis of the graph 1500 may denote the first feature 1440 and a y-axis of the graph 1500 may denote the second feature 1450.

According to an embodiment of the disclosure, the user embedding vector 1421 of the first user and the user embedding vector 1422 of the second user may be a latent vector or a latent factor, and indicate only a mathematical value. However, the user embedding vector 1421 of the first user and the user embedding vector 1422 of the second user may be generated according to a pre-set standard, based on feedback information. The first feature 1440 and the second feature 1450 may consequently denote axes related to a preference degree of a user for content. In detail, in a server for providing a recommendation application to a user, values of the first feature 1440 of users preferring a game application may be high, and values of the second feature 1450 of users preferring a finance application may be high. For example, a value of the first feature of the second user 1440 is higher than a value of the first feature of the first user, and thus the second user may be highly likely to prefer the game application more than the first user. Accordingly, in an embedding space corresponding to the graph 1500, which includes the user embedding vector 1421 of the first user and the user embedding vector 1422 of the second user, preference degrees of users for a plurality of pieces of content may be similar when distances between user embedding vectors are close.

FIG. 6 is a flowchart of a method of determining a plurality of user groups and central users of the plurality of user groups, according to an embodiment of the disclosure.

In operation S1610, a server may determine the plurality of user groups based on a pre-set number of the plurality of user groups and Euclidean distances between user embedding vectors for a plurality of users.

According to an embodiment of the disclosure, to determine the plurality of user groups based on the pre-set number of the plurality of user groups and the Euclidean distances between the user embedding vectors for the plurality of users, the server may change high-dimensional user embedding vectors for the plurality of users to pre-set low-dimensional user embedding vectors for the plurality of users. In detail, when a dimension of the user embedding vectors for the plurality of users is high, the high-dimensional user embedding vectors for the plurality of users may be changed to the pre-set low-dimensional user embedding vectors for the plurality of users, so as to resolve a storage space issue of the server by reducing a required time until recommendation content is provided to a user and reducing high-dimensional data to low-dimensional data.

According to an embodiment of the disclosure, the server may determine the plurality of user groups based on the pre-set number of the plurality of user groups and Euclidean distances between the changed user embedding vectors for the plurality of users. For example, the plurality of user groups may be determined such that a sum of variances of each of the plurality of user groups is minimized.

In operation S1620, the server may determine central users of the plurality of user groups based on Euclidean distances between user embedding vectors for at least one user belonging to each of the determined plurality of user groups.

According to an embodiment of the disclosure, the server may determine center points of the plurality of user groups based on the Euclidean distances between the user embedding vectors for the at least one user belonging to each of the determined plurality of user groups. For example, the center points of the plurality of user groups may correspond to vectors of averages of user embedding vectors for the at least one user belonging to each of the plurality of user groups. The server may determine the central users of the plurality of user groups based on the center points of the plurality of user groups. For example, the central users of the plurality of user groups may be users of the plurality of user groups located close to the center points of the plurality of user groups in an embedding space.

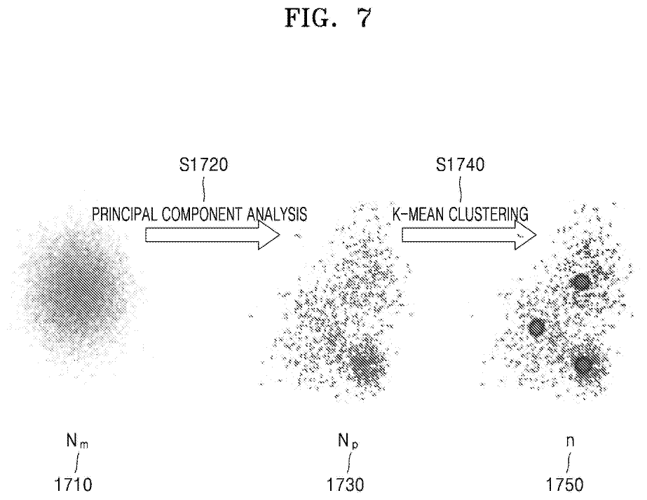

FIG. 7 is a diagram showing an example of determining central users of a plurality of user groups by grouping a plurality of users, according to an embodiment of the disclosure.

In operation S1720, a server may change high-dimensional user embedding vectors for a plurality of users to pre-set low-dimensional user embedding vectors for the plurality of users. For example, the server may change user embedding vectors of a high dimension Nm 1710 for the plurality of users to user embedding vectors of a pre-set low dimension Nₚ 1730 for the plurality of users. The Nₚ 1730 may be a value pre-set in consideration of a memory of the server and a required time until recommendation content is provided to a user, synthetically. Also, for example, the server may change the high-dimensional user embedding vectors for the plurality of users to the pre-set low-dimensional user embedding vectors for the plurality of users, through a principal component analysis (PCA).

In operation S1740, the server may determine a plurality of user groups based on a pre-set number of the plurality of user groups and Euclidean distances between the changed user embedding vectors for the plurality of users. In detail, the server may determine the plurality of user groups, through K-mean clustering, based on a pre-set number n 1750 of plurality of user groups and the Euclidean distances between the changed user embedding vectors for the plurality of users. Also, the pre-set number n 1750 of plurality of user groups may be a value pre-set or adjusted in consideration of the memory of the server and the required time until the recommendation content is provided to the user, collectively. For example, the plurality of user groups may be determined such that Equation 2 is satisfied through K-mean clustering.

$${arg min}_{S} {\sum }_{i = 1}^{n} {\sum }_{x ∈ {S}_{i}} {‖ x - {u}_{i} ‖}^{2} \qquad [ Equation 2 ]$$

S in Equation 2 may consist of {S₁, S₂, . . . , Sₙ}, and Sᵢ may denote an i-th group of a plurality of users. uᵢ may denote center points of the plurality of user groups, and

$${\sum }_{x ∈ {S}_{i}} {‖ x - {u}_{i} ‖}^{2}$$

may denote a variance calculated based on a distance between embedding vectors of users belonging to the i-th group of the plurality of users

$${\sum }_{x ∈ {S}_{i}} {‖ x - {u}_{i} ‖}^{2} .$$

may denote a variance of the i-th group.

According to an embodiment of the disclosure, the PCA and the k-mean clustering in FIG. 7 are merely examples for determining the plurality of user groups and the central users of the plurality of user groups, and an embodiment of the disclosure is not limited thereto.

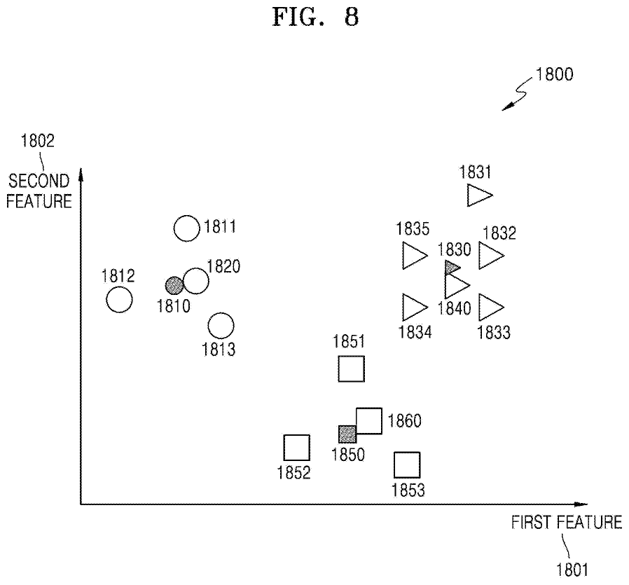

FIG. 8 is a diagram showing an example of determining central users of a plurality of user groups, in an embedding space, according to an embodiment of the disclosure.

According to an embodiment of the disclosure, a graph 1800 may be an embedding space including user embedding vectors. Dimensions of the user embedding vectors may be a first feature 1801 and a second feature 1802, and the embedding space may be divided into three user groups. For example, a first group may include a first user 1811, a second user 1812, a third user 1813, and a fourth user 1820, a second group may include a fifth user 1831, a sixth user 1832, a seventh user 1833, an eighth user 1834, a ninth user 1835, and a tenth user 1840, and a third group may include an eleventh user 1851, a twelfth user 1852, a thirteenth user 1853, and a fourteenth user 1860.

According to an embodiment of the disclosure, a server may determine center points of the plurality of user groups for each of the plurality of user groups. In detail, the server may determine the center points of the plurality of user groups based on user embedding vectors of at least one user belonging to each of the plurality of user groups. For example, the center points of the plurality of user groups may be determined based on averages of the user embedding vectors of at least one user belonging to each of the plurality of user groups. For example, a center point of the first group may be a first center point 1810, a center point of the second group may be a second center point 1830, and a center point of the third group may be a third center point 1850.

According to an embodiment of the disclosure, the server may determine central users of the plurality of user groups based on the determined center points of the plurality of user groups. For example, as shown in FIG. 8, a central user of the first group may be the fourth user 1820 located closest to the first center point 1810, a central user of the second group may be the tenth user 1840 located closest to the second center point 1830, and a central user of the third group may be the fourteenth user 1860 located closest to the third center point 1850.

The method for determining the central users of the plurality of user groups shown in FIG. 8 is only an example and is not limited thereto.

FIG. 9 is a diagram showing an example of training an artificial neural network model 1930, according to an embodiment of the disclosure.

According to an embodiment of the disclosure, the artificial neural network model 1930 of a server may be trained by using, as training data, user embedding vectors 1910 for a plurality of users and content embedding vectors 1920 for a plurality of pieces of content. In detail, the artificial neural network model 1930 may be periodically trained by using, as the training data, the user embedding vectors 1910 for the plurality of users and the content embedding vectors 1920 for the plurality of pieces of content, before receiving a content recommendation request from a device of a user who is a target of customized content recommendation. The artificial neural network model 1930 may include at least one of a generalized matrix factorization (GMF) model, a multi-layer perception (MLP) model, or a neural matrix factorization (NeuMF) model, but is not limited thereto.

According to an embodiment of the disclosure, the artificial neural network model 1930 may output preference vectors 1940 of central users indicating estimated preference degrees of the central users for the plurality of pieces of content. Also, the artificial neural network model 1930 may be trained by comparing the preference vectors 1940 of the central users and feedback information 1950. In detail, the artificial neural network model 1930 may be iteratively trained through the estimated preference degrees of the central users for the plurality of pieces of content, which are output from the artificial neural network model 1930, and data on preference degrees of the central users for the plurality of pieces of content, which is included in the feedback information 1950.

FIG. 10 is a diagram for describing the artificial neural network model 1930, according to an embodiment of the disclosure.

According to an embodiment of the disclosure, the artificial neural network model 1930 may include at least one of a GMF model 2030, an MLP model 2040, and an NeuMF model 2050. User embedding vectors for a plurality of users and content embedding vectors for a plurality of pieces of content may be used as inputs of the artificial neural network model 1930.

According to an embodiment of the disclosure, a user embedding vector 2010 of a user i may include a plurality of user embedding vectors of the user i. For example, a first user embedding vector 2011 of the user i may be input to the GMF model 2030, and a second user embedding vector 2012 of the user i may be input to the MLP model 2040. The first user embedding vector 2011 and the second user embedding vector 2012 may be user embedding vectors generated by using any one of various methods, and are not limited to examples described herein.

According to an embodiment of the disclosure, a content embedding vector 2020 of content j may include a plurality of content embedding vectors of the content j. For example, a first content embedding vector 2024 of the content j may be input to the GMF model 2030, and a second content embedding vector 2023 of the content j may be input to the MLP model 2040. The first content embedding vector 2024 and the second content embedding vector 2023 may be content embedding vectors generated by using any one of various methods, and are not limited to examples described herein.

According to an embodiment of the disclosure, the GMF model 2030 may correspond to a special example of a neural collaborative filtering (NCF) model, and estimate linear preference degrees of the plurality of users for the plurality of pieces of content. The MLP model 2040 according to an embodiment of the disclosure may include a plurality of layers, and may estimate nonlinear preference degrees of the plurality of users for the plurality of pieces of content. The NeuMF model 2050 according to an embodiment of the disclosure may output an estimated preference degree y_{îj} 2060 of the user i for the content j, based on an output value of the GMF model 2030 and an output value of the MLP model 2040.

Also, according to an embodiment of the disclosure, a feedback vector of the user i may be obtained from feedback information (for example, the feedback information 1950 of FIG. 9), and a value of a j-th element of the feedback vector of the user i may be a preference degree yᵢⱼ 2070 of the user i for the content j, which is obtained based on behavior data of the user i for the content j.

According to an embodiment of the disclosure, the artificial neural network model 1930 may be trained based on the estimated preference degree y_{îj} 2060 of the user i for the content j, and the preference degree yᵢⱼ 2070 of the user i for the content j. For example, the artificial neural network model 1930 may be trained based on the estimated preference degree y_{îj} 2060 of the user i for the content j and the preference degree yᵢⱼ 2070 of the user i for the content j, according to Equation 3.

$${L}_{sqr} = {\sum }_{( u , i ) ∈ y ⋃ y -} {{w}_{ui} ( {y}_{ui} - \hat{{y}_{ui}} )}^{2} \qquad [ Equation 3 ]$$

In Equation 3, y denotes a set in which preference degrees of a plurality of users for a plurality of pieces of content are “positive”, and y⁻ denotes a set in which preference degrees of a plurality of users for a plurality of pieces of content are “negative”. According to the present specification, yᵤᵢ of a user u for content i, which belong to y or y⁻, is 1 or 0, and thus L_{sqr} may be a real number. The artificial neural network model 1930 may be trained such L_{sqr} that is less than or equal to a pre-set threshold value.

FIG. 11 is a flowchart of a method of determining at least one piece of recommendation content to be recommended to a user, according to an embodiment of the disclosure.

In operation S2110, a server may select a central user to be used to recommend content based on a feedback vector of the user and preference vectors of central users.

According to an embodiment of the disclosure, the server may select the central user to be used to recommend content, by comparing the feedback vector of the user and the preference vectors of the central users. In detail, the central user to be used to recommend content may be selected based on inner products or difference values between the feedback vector of the user and the preference vectors of the central users. For example, the inner products between the feedback vector of the user and the preference vectors of the central users may be calculated, and a central user having a highest value of the inner product may be selected as the central user to be used to recommend content.

Alternatively, the central user to be used to recommend content may be selected according to the difference values between the feedback vector of the user and the preference vectors of the central users, based on Equation 4 below. For example, it may be determined that preference degrees of the central users for a plurality of pieces of content are similar to preference degrees of the user, who is a target of content recommendation, for the plurality of pieces of content, when the difference values (Loss) with respect to the central users are small.

$${Loss}_{m} = {{\sum }_{( u , i ) ∈ y ⋃ y - ,}}_{u = m} {{w}_{ui} ( {y}_{ui} - \hat{{y}_{ui}} )}^{2} \qquad [ Equation 4 ]$$

Lossₘ may denote a difference value of a central user m, and wᵤᵢ may is a pre-set hyper parameter and denote a weight.

According to an embodiment of the disclosure, similarity values between estimated preference degrees of the central users for the plurality of pieces of content and the preference degrees of the user for the plurality of pieces of content may be determined based on the inner products between the feedback vector of the user and the preference vectors of the central users or based on the difference values between the feedback vector of the user and the preference vectors of the central users. For example, the similarity values between the estimated preference degrees of the central users for the plurality of pieces of content and the preference degrees of the user for the plurality of pieces of content may be determined to be high, when the inner products between the feedback vector of the user and the preference vectors of the central users are large or when the difference values between the feedback vector of the user and the preference vectors of the central users are small.

In operation S2120, the server may extract a preference vector of the selected central user from the preference vectors of the central users.

According to an embodiment of the disclosure, the server may extract the preference vector of the selected central user from the preference vectors of the central users. The selected central user may be a user estimated to have a preference degree most similar to the preference degrees of the user for the plurality of pieces of content.

In operation S2130, at least one piece of recommendation content may be determined based on the extracted preference vector.

According to an embodiment of the disclosure, the at least one piece of recommendation content may be determined based on element values of the extracted preference vector. In detail, the at least one piece of recommendation content may be determined based on a pre-set number stored in the server and the element values of the extracted preference vector. For example, the pre-set number of element values having high element values in preference vectors may be selected from the extracted preference vector, and at least one piece of content corresponding to the selected element values of the preference vector may be determined as customized content to be recommended to the user.

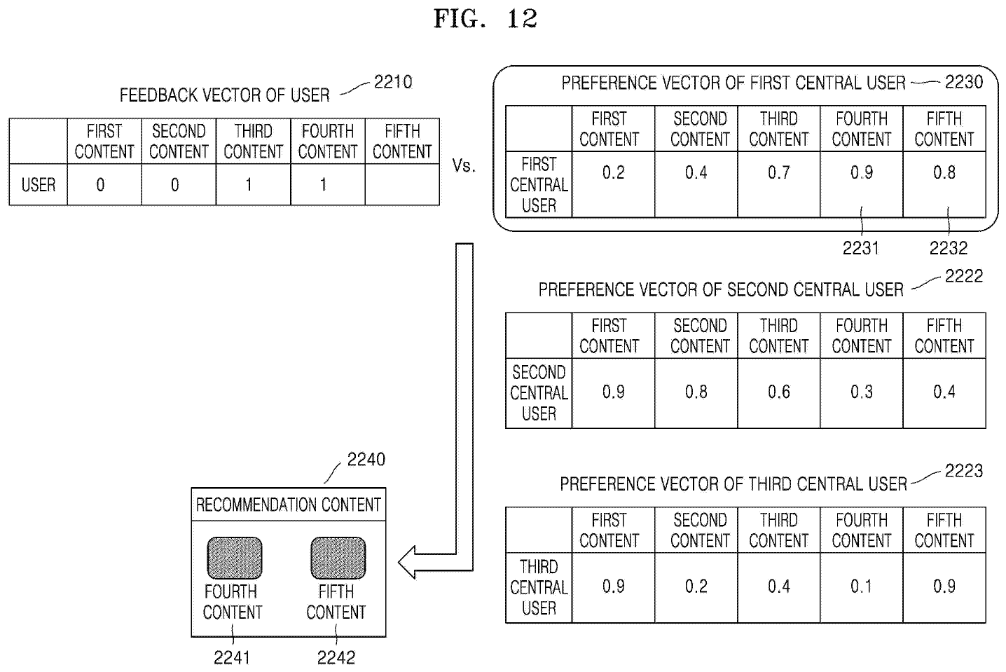

FIG. 12 is a diagram showing an example of at least one piece of recommendation content 2240 to be recommended to a user, according to an embodiment of the disclosure.

According to an embodiment of the disclosure, inner products between a feedback vector 2210 of the user and preference vectors of central users may be calculated, and a central user having a highest value of the inner product may be selected as a central user to be used to recommend content. As shown in FIG. 12, the preference vectors of the central users may include a preference vector 2230 of a first central user, a preference vector 2222 of a second central user, and a preference vector 2223 of a third central user.

According to an embodiment of the disclosure, the inner product between the feedback vector 2210 of the user and the preference vector of the central user may be calculated through a sum of multiplications between corresponding elements, except for an element in which a value is blank. For example, an inner product between the feedback vector 2210 of the user and the preference vector 2230 of the first central user may be calculated according to 1×0.7+1×0.9=1.6, and similarly, an inner product between the feedback vector 2210 of the user and the preference vector 2222 of the second central user may be calculated to be 0.9, and an inner product between the feedback vector 2210 of the user and the preference vector 2223 of the third central user may be calculated to be 0.5. Accordingly, the first central user whose value of the inner product is 1.6 may be selected as a central user having the most similar preference degree as the user for content, and the first central user may be selected as the central user to be used to recommend content.

According to an embodiment of the disclosure, a server may determine the at least one piece of recommendation content 2240 to be recommended to the user, based on element values of the preference vector 2230 of the first central user. For example, when it is pre-set to provide two pieces of recommendation content to the user, high element values 0.9 2231 and 0.8 2232 of the preference vector 2230 of the first central user may be selected, and the recommendation content 2240 including fourth content 2241 and fifth content 2242 corresponding to the selected element values 0.9 2231 and 0.8 2232 may be determined.

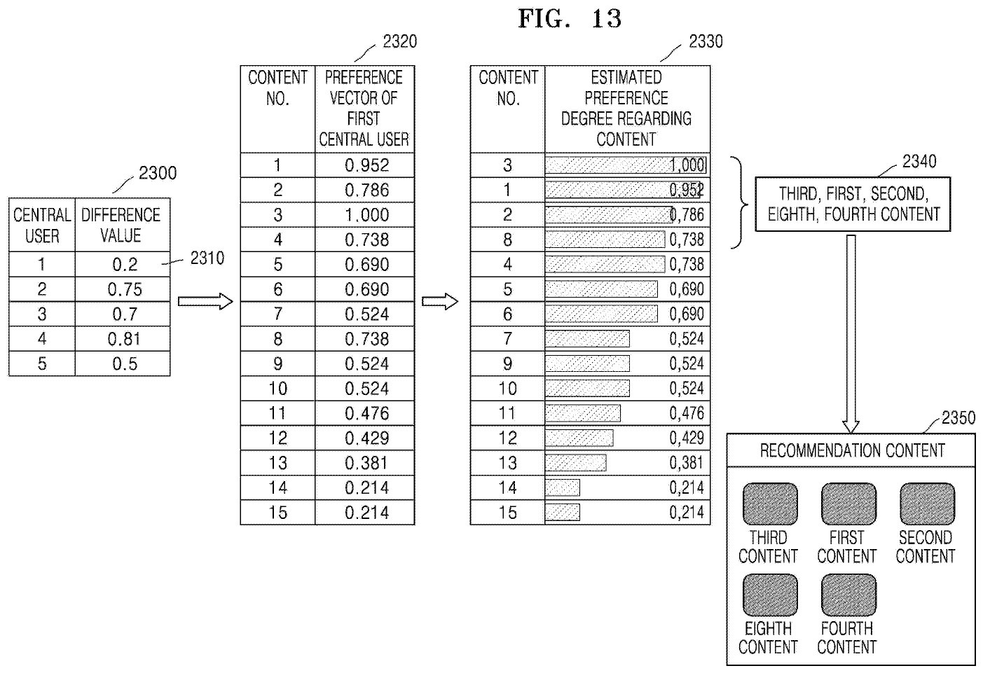

FIG. 13 is a diagram showing an example of at least one piece of recommendation content 2350 to be recommended to a user, based on difference values of central users, according to an embodiment of the disclosure.

According to an embodiment of the disclosure, a first table 2300 for the difference values of the central users may be obtained based on preference vectors of the central users and a feedback vector of the user, and a central user to be used to recommend content may be selected based on the first table 2300. For example, among the difference values in the first table 2300, a difference value 2310 of a first central user is the smallest, i.e. 0.2, and thus the first central user may be selected as the central user to be used to recommend content.

According to an embodiment of the disclosure, preference vectors 2320 of the first central user may be vectors indicating estimated preference degrees for first content through fifteenth content. The preference vectors 2320 of the first central user may be aligned in a descending order of values of the estimated preference degrees, and may be represented as a second table 2330.

According to an embodiment of the disclosure, at least one piece of recommendation content 2350 to be recommended to the user may be determined based on the second table 2330 and a pre-set number of pieces of content to be provided as recommendation content to the user. For example, when it is pre-set to recommend 5 pieces of content to the user, a server may determine, as the recommendation content 2350, third, first, second, eighth, fourth content 2340, which have highest values of estimated preference degrees for content.

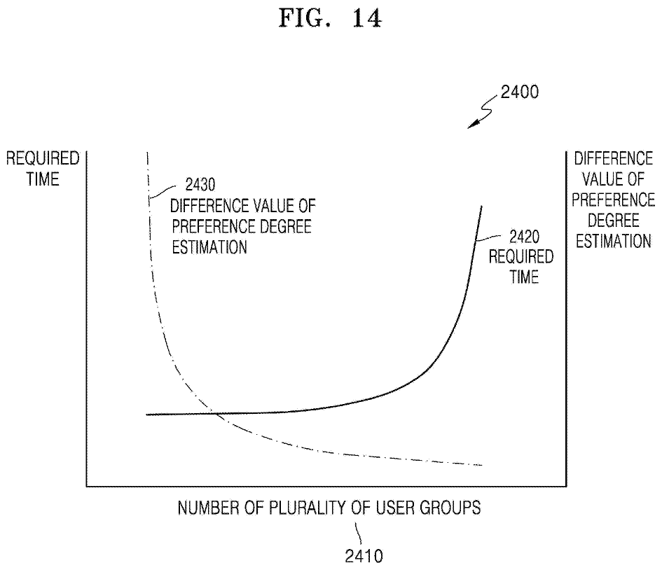

FIG. 14 is a diagram of a required time 2420 until recommendation content is provided to a user and a difference value 2430 of content preference degree estimation, according to the number 2410 of a plurality of user groups, according to an embodiment of the disclosure.

According to an embodiment of the disclosure, a graph 2400 shows the required time 2420 until recommendation content is provided and the difference value 2430 of the content preference degree estimation, according to the number 2410 of plurality of user groups. An x-axis of the graph 2400 indicates the number 2410 of plurality of user groups, and a y-axis of the graph 2400 indicates the required time 2420 until recommendation content is provided and the difference value 2430 of the content preference degree estimation.

According to an embodiment of the disclosure, when the number 2410 of plurality of user groups increases, user embedding vectors of more central users may be required to be input to an artificial neural network model so as to provide recommendation content to the user. Accordingly, when the number 2410 of plurality of user groups increases, the required time 2420 for providing the recommendation content to the user may increase.

According to an embodiment of the disclosure, when the number 2410 of plurality of user groups increases, the server provides the recommendation content to the user by comparing preference degrees of more central users and the user, and thus the difference value 2430 of content preference degree estimation may decrease.

Accordingly, the number 2410 of plurality of user groups may be suitably determined considering, synthetically, the required time 2420 until the recommendation content is provided, the difference value 2430 of content preference degree estimation, and a memory of the server. When the suitable number 2410 of plurality of user groups is determined, the server may provide the customized recommendation content to the user, and at the same time, rapidly reduce the required time until the recommendation content is provided.

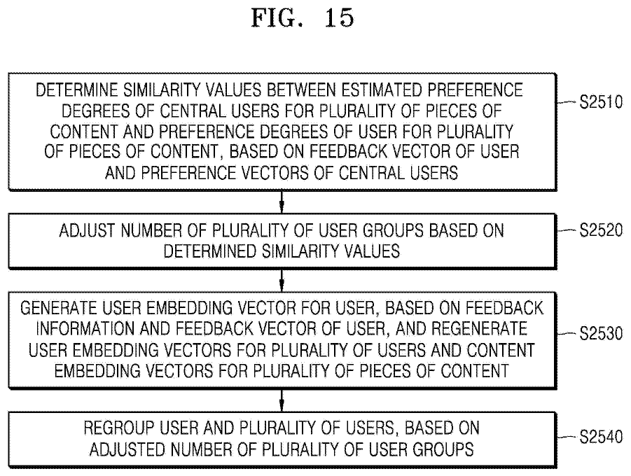

FIG. 15 is a flowchart of a method of adjusting the number of a plurality of user groups and regrouping a user and a plurality of users, based on the adjusted number of the plurality of user groups, according to an embodiment of the disclosure.

In operation S2510, a server may determine similarity values between estimated preference degrees of central users for a plurality of pieces of content and preference degrees of a user for the plurality of pieces of content, based on a feedback vector of the user and preference vectors of the central users.

According to an embodiment of the disclosure, the server may determine the similarity values between the estimated preference degrees of the central users for the plurality of pieces of content, and the preference degrees of the user for the plurality of pieces of content. In detail, the similarity values between the estimated preference degrees of the central users for the plurality of pieces of content and the preference degrees of the user for the plurality of pieces of content may be determined based on inner products between the feedback vector of the user and the preference vectors of the central users or based on difference values between the feedback vector of the user and the preference vectors of the central users. For example, the similarity values between the estimated preference degrees of the central users for the plurality of pieces of content and the preference degrees of the user for the plurality of pieces of content may be calculated to be high, when the inner products between the feedback vector of the user and the preference vectors of the central users are large or when the difference values between the feedback vector of the user and the preference vectors of the central users are small.

In operation S2520, the server may adjust the number of the plurality of user groups based on the determined similarity values.

According to an embodiment of the disclosure, the server may determine a highest similarity value from among the determined similarity values, and select a central user having the highest similarity value. For example, the server may determine whether to adjust the number of the plurality of user groups, by comparing the highest similarity value with a pre-set threshold value stored in the server.

In operation S2530, a user embedding vector for the user may be generated based on feedback information and the feedback vector of the user, and user embedding vectors for a plurality of users and content embedding vectors for the plurality of pieces of content may be regenerated.

According to an embodiment of the disclosure, the server may obtain feedback information and feedback vectors, based on behaviors, actions, and reactions of the user and the plurality of users for the plurality of pieces of content. For example, the server may generate the user embedding vector for the user, based on the feedback information and feedback vector, and regenerate the user embedding vectors for the plurality of users and the content embedding vectors for the plurality of pieces of content. Also, the server may pre-train an artificial neural network model by inputting, to the artificial neural network model, the generated user embedding vector for the user, the regenerated user embedding vectors for the plurality of users, and the regenerated content embedding vectors for the plurality of pieces of content. Also, when a new user transmits a content recommendation request, recommendation content may be provided to the new user, based on the generated user embedding vector for the user, the regenerated user embedding vectors for the plurality of users, and the regenerated content embedding vectors for the plurality of pieces of content.

In operation S2540, the user and the plurality of users may be regrouped based on the adjusted number of the plurality of user groups.

According to an embodiment of the disclosure, the user and the plurality of users may be regrouped based on generated user embedding vector for the user, the regenerated user embedding vectors for the plurality of users, the regenerated content embedding vectors for the plurality of pieces of content, and the adjusted number of the plurality of user groups.

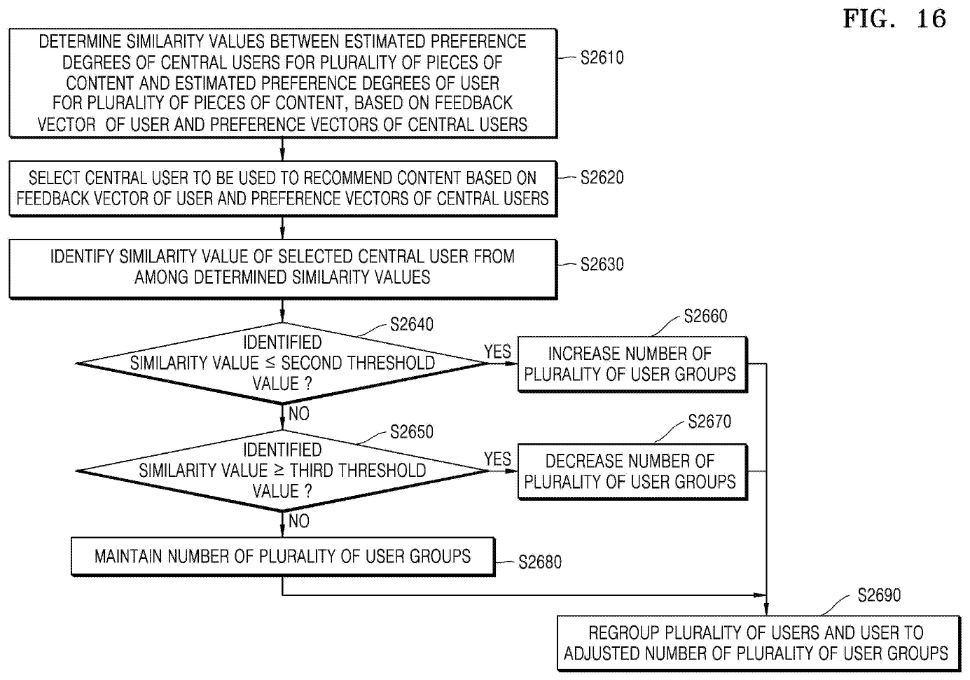

FIG. 16 is a flowchart of a method of determining whether to adjust the number of a plurality of user groups based on a similarity value of a selected central user, and when it is determined to adjust the number of the plurality of user groups, regrouping a plurality of users and a user according to the adjusted number of the plurality of user groups, according to an embodiment of the disclosure.

In operation S2610, a server may determine similarity values between estimated preference degrees of central users for a plurality of pieces of content and estimated preference degrees of a user for the plurality of pieces of content, based on a feedback vector of the user and preference vectors of the central users.

According to an embodiment of the disclosure, inner products or difference values between the feedback vector of the user and the preference vectors of the central users may be calculated, based on the feedback vector of the user and the preference vectors of the central users. Also, the similarity values between the estimated preference degrees of the central users for the plurality of pieces of content, and the estimated preference degrees of the user for the plurality of pieces of content may be determined based on the calculated inner products or difference values.

In operation S2620, the server may select a central user to be used to recommend content based on the feedback vector of the user and the preference vectors of the central users.

According to an embodiment of the disclosure, the server may select, as the central user to be used to recommend content, a central user having a pre-determined highest similarity value, based on the feedback vector of the user and the preference vectors of the central users.

In operation S2630, the server may identify a similarity value of the selected central user from among the determined similarity values.

According to an embodiment of the disclosure, the server may select, as the central user to be used to recommend content, a central user having a pre-determined highest similarity value, based on the feedback vector of the user and the preference vectors of the central users, and thus may identify the highest similarity value from among the determined similarity values.

In operation S2640, the server may compare the identified similarity value with a second threshold value to determine whether to increase the number of the plurality of user groups.

According to an embodiment of the disclosure, the server may compare the identified similarity value with the second threshold value to determine whether to increase the number of the plurality of user groups, wherein the second threshold value may be a value pre-set in consideration of a size of a memory, the number of the plurality of user groups, and a size of data about behaviors, reactions, and the like related to preference degrees of the plurality of users for the plurality of pieces of content, the data being stored in the memory. For example, when the identified similarity value is equal to or less than the pre-set second threshold value, the server may adjust the number of the plurality of user groups by increasing the number of the plurality of user groups, in operation S2660. Alternatively, for example, when the identified similarity value is greater than the pre-set second threshold value, the server may compare the identified similarity value with a third threshold value to determine whether to decrease the number of the plurality of user groups, in operation S2650.

In operation S2650, the server may compare the identified similarity value with the third threshold value to determine whether to decrease the number of the plurality of user groups.

According to an embodiment of the disclosure, the server may compare the identified similarity value with the third threshold value to determine whether to decrease the number of the plurality of user groups, wherein the third threshold value may be a value pre-set in consideration of the size of the memory, the number of the plurality of user groups, and the size of data about behaviors, reactions, and the like related to the preference degrees of the plurality of users for the plurality of pieces of content, the data being stored in the memory. For example, the third threshold value may be smaller than the second threshold value. For example, when the identified similarity value is equal to or greater than the pre-set third threshold value, the server may adjust the number of the plurality of user groups by decreasing the number of the plurality of user groups, in operation S2670. Alternatively, for example, when the identified similarity value is less than the pre-set third threshold value, the server may maintain the number of the plurality of user groups, in operation S2680.

In operation S2660, when the identified similarity value is equal to or less than the pre-set second threshold value, the server may adjust the number of the plurality of user groups by increasing the number of the plurality of user groups.

In operation S2670, when the identified similarity value is equal to or greater than the pre-set third threshold value, the server may adjust the number of the plurality of user groups by decreasing the number of the plurality of user groups.

In operation S2680, when the identified similarity value is less than the pre-set third threshold value, the server may maintain the number of the plurality of user groups.

In operation S2690, the server may regroup the user and the plurality of users to the adjusted number of the plurality of user groups.

According to an embodiment of the disclosure, the server may regroup the user and the plurality of users, based on the adjusted number of the plurality of user groups, the feedback vector of the user, and feedback information of the plurality of users. In detail, the server may regenerate a user embedding vector of the user, user embedding vectors of the plurality of users, and content embedding vectors of the plurality of pieces of content, based on the adjusted number of the plurality of user groups, the feedback vector of the user, and the feedback information of the plurality of users. Also, the server may regroup the user and the plurality of users, based on the regenerated user embedding vector of the user, the user embedding vectors of the plurality of users, and the content embedding vectors of the plurality of pieces of content. For example, the server may regroup the user and the plurality of users, based on at least one of Principal Component Analysis (PCA) or k-mean clustering.

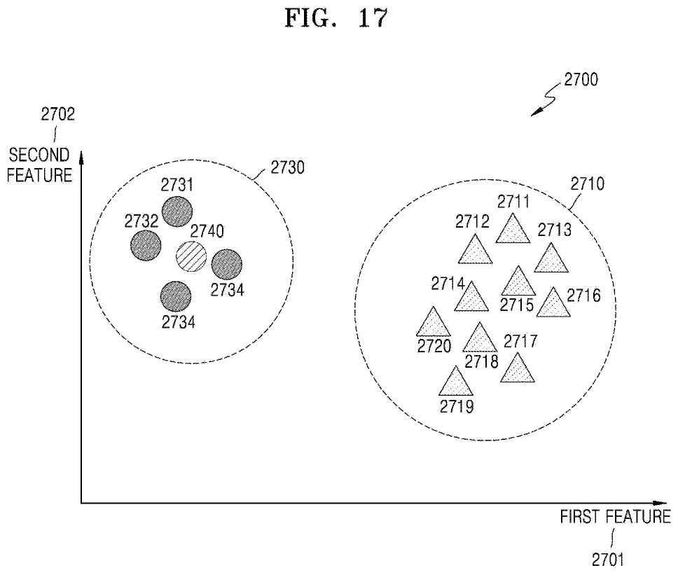

FIG. 17 is a diagram showing an example of, when the number of the plurality of user groups is decreased in FIG. 16, regrouping a plurality of users and a user to the adjusted number of the plurality of user groups, according to an embodiment of the disclosure.

According to an embodiment of the disclosure, a graph 2700 may show an embedding space including user embedding vectors of a plurality of users, where an x-axis of the graph 2700 is a first feature 2701 and a y-axis of the graph 2700 is a second feature 2702.

According to an embodiment of the disclosure, the number of the plurality of user groups may be adjusted from 3 to 2, in operation S2670. For example, a first group 2710 may include first through tenth users 2711 through 2720. Also, for example, a second group 2730 may include eleventh through fourteenth users 2731 through 2734 and a user 2740. The plurality of user groups may be regrouped into the first group 2710 and the second group 2730, and the user 2740 may be a user who is a target of content recommendation.

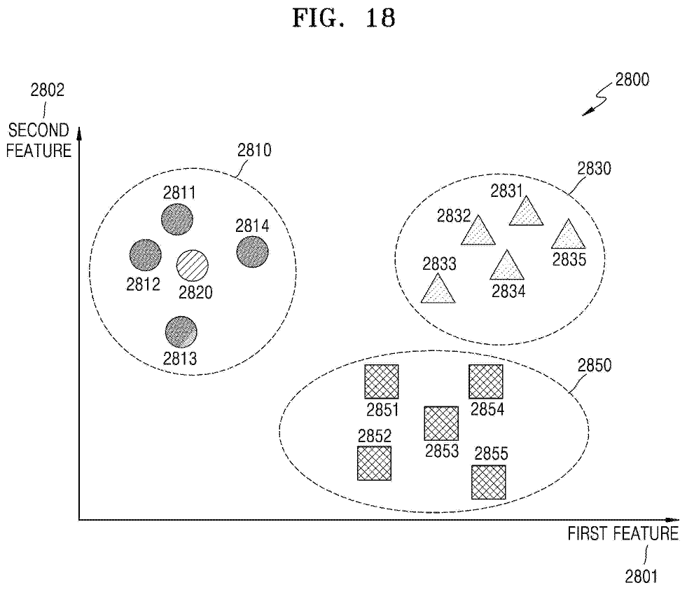

FIG. 18 is a diagram showing an example of regrouping a plurality of users and a user when the number of the plurality of user groups is maintained in FIG. 16, according to an embodiment of the disclosure.

According to an embodiment of the disclosure, a graph 2800 may show an embedding space including user embedding vectors of a plurality of users, where an x-axis of the graph 2800 is a first feature 2801 and a y-axis of the graph 2800 is a second feature 2802.

According to an embodiment of the disclosure, the number of the plurality of user groups may be maintained to 3, in operation S2680. For example, a first group 2810 may include first through fourth users 2811 through 2814 and a user 2820. Also, for example, a second group 2830 may include fifth through ninth users 2831 through 2835. Also, for example, a third group 2850 may include tenth through fourteenth users 2851 through 2855. For example, the plurality of user groups may be regrouped into the first group 2810, the second group 2830, and the third group 2850, where the user 2820 may be a user who is a target of content recommendation.

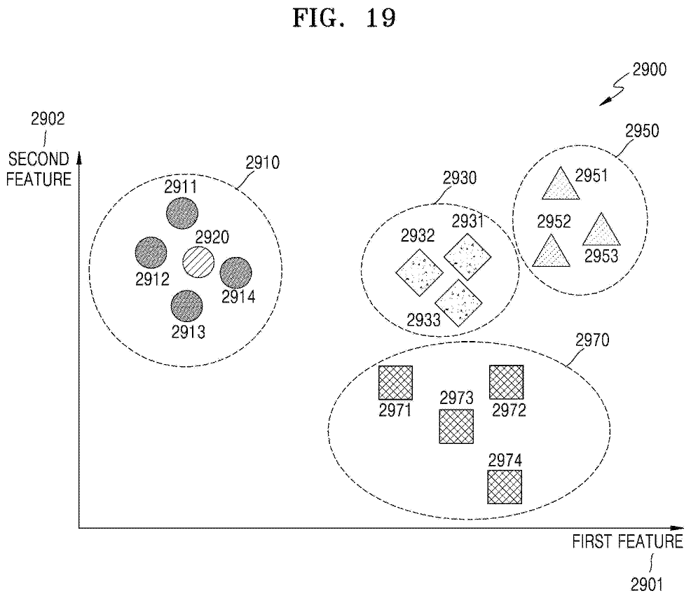

FIG. 19 is a diagram showing an example of regrouping a plurality of users and a user to the adjusted number of the plurality of user groups when the number of the plurality of user groups is increased in FIG. 16, according to an embodiment of the disclosure.

According to an embodiment of the disclosure, a graph 2900 may show an embedding space including user embedding vectors of a plurality of users, wherein an x-axis of the graph 2900 is a first feature 2901 and a y-axis of the graph 2900 is a second feature 2902.

According to an embodiment of the disclosure, the number of the plurality of user groups may be adjusted from 3 to 4, in operation S2660. For example, a first group 2910 may include first through fourth users 2911 through 2914 and a user 2920. Also, for example, a second group 2930 may include fifth through seventh users 2931 through 2933. Also, for example, a third group 2950 may include eighth through tenth users 2951 through 2953. Also, for example, a fourth group 2970 may include eleventh through fourteenth users 2971 through 2974. For example, the plurality of user groups may be regrouped into the first group 2910, the second group 2930, the third group 2950, and the fourth group 2970, where the user 2920 may be a user who is a target of content recommendation.

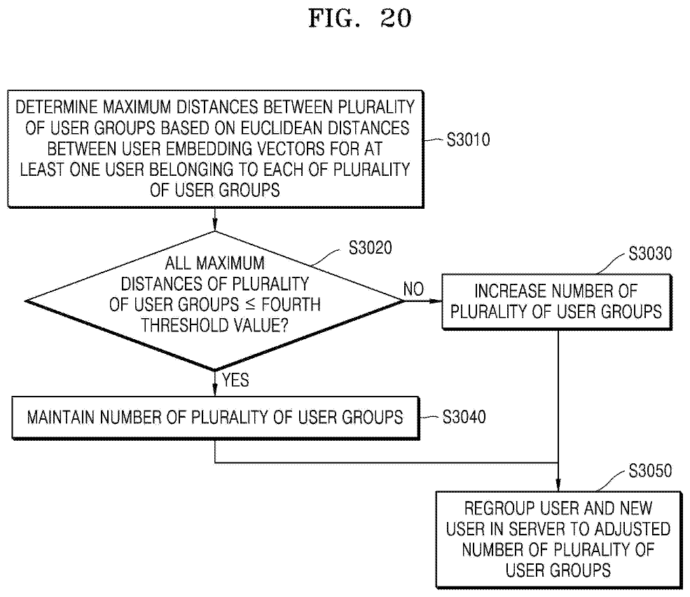

FIG. 20 is a flowchart of a method of determining whether to adjust the number of a plurality of user groups based on Euclidean distances between user embedding vectors for at least one user belonging to each of the plurality of user groups, and when it is determined to adjust the number of the plurality of user groups, regrouping a plurality of users and a user to the adjusted number of the plurality of user groups, according to an embodiment of the disclosure.

According to an embodiment of the disclosure, a server may adjust the number of the plurality of user groups by comparing the Euclidean distances between the user embedding vectors for the at least one user belonging to each of the plurality of user groups with a pre-set fourth threshold value. In detail, for an arbitrary user group from among the plurality of user groups, when a distance in an embedding space between a first user and a second user belonging to the arbitrary user group is equal to or greater than a threshold value, the server may adjust the number of the plurality of user groups by increasing the same because it is not appropriate that the first user and the second user belong to a same user group.

In operation S3010, the server may determine maximum distances of the plurality of user groups based on Euclidean distances between user embedding vectors for at least one user belonging to each of the plurality of user groups.

According to an embodiment of the disclosure, the server may calculate the Euclidean distances between the user embedding vectors for the at least one user belonging to each of the plurality of user groups. In detail, the server may determine that preference degrees of a plurality of users for content are similar when locations of the plurality of users are close in the embedding space. Also, the maximum distances of the plurality of user groups may be determined based on the calculated Euclidean distances between the user embedding vectors for at least one user belonging to each of the plurality of user groups. For example, regarding a first group from among the plurality of user groups, the server may select a first user and a second user having a farthest Euclidean distance from among the Euclidean distances between the user embedding vectors for at least one user belonging to the first group. Also, for example, the server may determine the Euclidean distance between the user embedding vector of the first user and the user embedding vector of the second user as a maximum distance of the first group, but an embodiment of the disclosure is not limited thereto.

In operation S3020, the server may compare maximum distances of the plurality of all user groups with the fourth threshold value to determine whether to adjust the number of the plurality of user groups.

According to an embodiment of the disclosure, the server may compare the maximum distances of the plurality of all user groups with the fourth threshold value to determine whether to adjust the number of the plurality of user groups, where the fourth threshold value may be a value pre-determined considering the number of the plurality of user groups, a size of a memory, and a required time until recommendation content is provided. For example, when the maximum distances of the plurality of all user groups are equal to or less than the fourth threshold value, the server may determine to maintain the number of the plurality of user groups, in operation S3040. Alternatively, for example, when at least one of the maximum distances of the plurality of all user groups is greater than the fourth threshold value, the server may adjust the number of the plurality of user groups by increasing the same, in operation S3030.

In operation S3030, the server may adjust the number of the plurality of user groups by increasing the same when at least one of the maximum distances of the plurality of all user groups is greater than the fourth threshold value.

In operation S3040, when the maximum distances of the plurality of all user groups are equal to or less than the fourth threshold value, the server may determine to maintain the number of the plurality of user groups.

In operation S3050, the server may regroup the user and a new user to the adjusted number of the plurality of user groups.

According to an embodiment of the disclosure, the server may regroup the user and a plurality of users, based on the adjusted number of the plurality of user groups, a feedback vector of the user, and feedback information of the plurality of users. In detail, the server may regenerate a user embedding vector of the user, user embedding vectors of the plurality of users, and content embedding vectors of a plurality of pieces of content, based on the adjusted number of the plurality of user groups, the feedback vector of the user, and the feedback information of the plurality of users. Also, the user and the plurality of users in the server may be regrouped based on the regenerated user embedding vector of the user and the regenerated user embedding vectors of the plurality of users. For example, the server may regroup the user and the plurality of users, based on at least one of PCA or k-mean clustering.

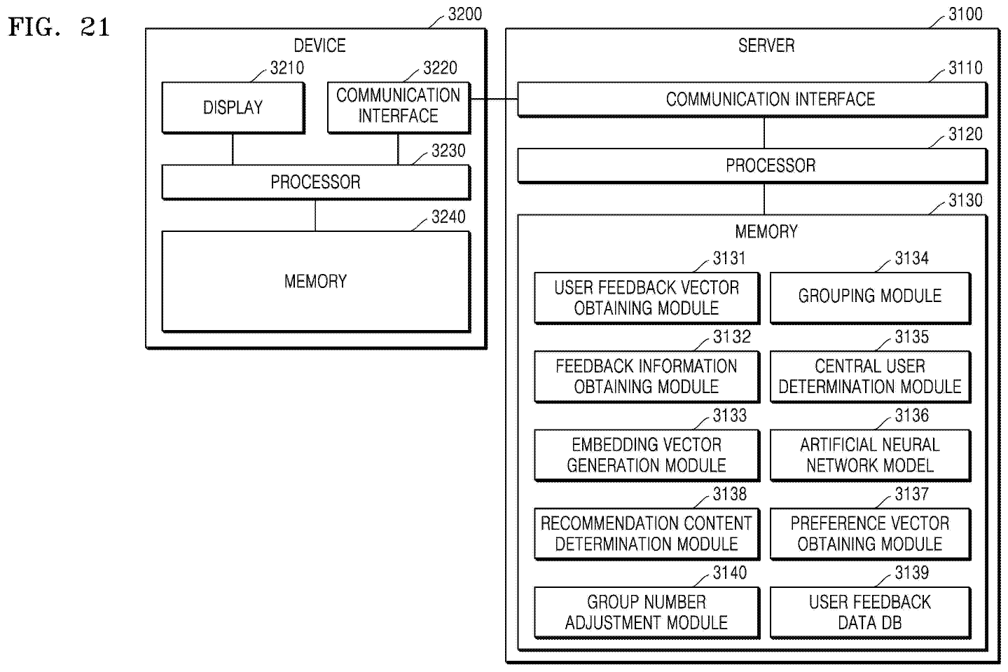

FIG. 21 is a block diagram of a server 3100 according to an embodiment of the disclosure.

Referring to FIG. 21, the server 3100 may include a communication interface 3110, a processor 3120, and a memory 3130, and the memory 3130 may include a user feedback vector obtaining module 3131, a feedback information obtaining module 3132, an embedding vector generation module 3133, a grouping module 3134, a central user determination module 3135, an artificial neural network model 3136, a preference vector obtaining module 3137, a recommendation content determination module 3138, a user feedback data database (DB) 3139, and a group number adjustment module 3140.

Referring to FIG. 21, a device 3200 may include a display 3210, a communication interface 3220, a processor 3230, and a memory 3240

Behaviors, reactions, and actions of a user for a plurality of pieces of content may be input through a user input unit (not shown) of the device 3200. In detail, the display 3210 may be a touch screen, and the touch screen may be used as an input unit. For example, behaviors of the user clicking or scrolling the plurality of pieces of content through the touch screen may be behaviors, reactions, or the like of the user for the plurality of pieces of content.

The device 3200 may be devices of a plurality of users, and may transmit, to the server 3100 through the communication interface 3220, a history or data about behaviors, reactions, and actions related to preference degrees of the plurality of users for the plurality of pieces of content. For example, referring to FIG. 1, data about behaviors, reactions, or actions of the first user 1001 for the plurality of pieces of content may be transmitted to the server 3100 through a device of the first user 1001, and data about behaviors, reactions, or actions of the second user 1002 and third user 1003 of FIG. 1 for the plurality of pieces of content may also be transmitted to the server 3100 through a device of the second user 1002 and a device of the third user 1003. Alternatively, the device 3200 may be a device of a user who is a target of content recommendation (for example, the user 1004 of FIG. 1). Also, the behaviors, reactions, and actions related to the preference degrees of the user for the plurality of pieces of content may be updated by the processor 3230, stored in the memory 3240, and periodically transmitted to the server 3100. For example, behaviors of the user scoring the plurality of pieces of content by the update through the processor 3230 may also be included in the behaviors, reactions, and actions related to the preference degrees of the user for the plurality of pieces of content. Also, for example, the behaviors, reactions, and actions related to the preference degrees of the user for the plurality of pieces of content may be stored in the memory 3240 for a pre-set certain period of time, and then periodically transmitted to the server 3100.

The device 3200 may include a smartphone, a tablet personal computer (PC), a PC, a smart television (TV), a mobile phone, a personal digital assistant (PDA), a laptop computer, a media player, a micro server, a global positioning system (GPS) device, an electronic book terminal, a digital broadcasting terminal, a navigation device, a kiosk, an MP3 player, a digital camera, a home appliance, or another mobile or non-mobile computing device, but is not limited thereto. The device 3200 may be a wearable device, such as a watch, glasses, a hair band, or a ring, having a communication function and a data processing function.

A network communicably connecting the device 3200 and the server 3100 may be implemented in any type of wired network, such as a local area network (LAN), a wide area network (WAN), or a value-added network (VAN), or any type of wireless network, such as a mobile radio communication network or a satellite communication network. The network may include a combination of at least two of LAN, WAN, VAN, a mobile radio communication network, or a satellite communication network. The network is a data communication network having a comprehensive meaning, which enables seamless communication between network entities shown in FIG. 21, and includes wired Internet, wireless Internet, and a mobile radio communication network. Examples of wireless communication may include wireless LAN (Wi-Fi), Bluetooth, Bluetooth low energy (BLE), Zigbee, Wi-Fi direct (WFD), ultra wideband (UWB), infrared data association (IrDA), and near field communication (NFC), but are not limited thereto.

The communication interface 3110 may include at least one component for communicating with the device 3200. The communication interface 3110 may transmit or receive, to or from the device 3200, information required to provide customized recommendation content to a user.

Also, the communication interface 3110 may communicate with another device (not shown) or another server (not shown) to provide the customized recommendation content to the user. For example, the communication interface 3110 may include a short-range wireless communicator, a mobile communicator, and a broadcast receiver. The short-range wireless communicator may include a Bluetooth communicator, a BLE communicator, a near field communicator, a WLAN (Wi-Fi) communicator, a Zigbee communicator, an IrDA communicator, a WFD communicator, a UWB communicator, or an Ant+ communicator, but is not limited thereto. The mobile communicator may transmit or receive a wireless signal to or from at least one of a base station, an external terminal, or a server, on a mobile communication network. Here, the wireless signal may include various types of data according to exchange of a voice call signal, an image call signal, or a text/multimedia message. The broadcast receiver may receive a broadcast signal and/or information related to a broadcast from an external source through a broadcast channel. The broadcast channel may include a satellite channel or a terrestrial channel.

The processor 3120 controls overall operations of the server 3100. For example, the processor 3120 may execute programs stored in the memory 3130, which will be described below, to control functions of the server 3100 for recommending content, according to an embodiment of the disclosure.

The memory 3130 may store programs for processes and controls by the processor 3120. The memory 3130 may include at least one type of storage medium among a flash memory type, a hard disk type, a multimedia card micro type, a card type memory (for example, a secure digital (SD) or an extreme digital (XD) memory), a random access memory (RAM), a static RAM (SRAM), a read-only memory (ROM), an electrically erasable programmable ROM (EEPROM), a programmable ROM (PROM), a magnetic memory, a magnetic disk, and an optical disk.

The programs stored in the memory 3130 may be classified into a plurality of modules depending on functions thereof, and for example, the memory 3130 may include the user feedback vector obtaining module 3131, the feedback information obtaining module 3132, the embedding vector generation module 3133, the grouping module 3134, the central user determination module 3135, the artificial neural network model 3136, the preference vector obtaining module 3137, the recommendation content determination module 3138, the user feedback data database (DB) 3139, and the group number adjustment module 3140.

The user feedback vector obtaining module 3131 may also obtain a feedback vector of the user who is a target of recommendation. In detail, the user feedback vector obtaining module 3131 may also obtain the feedback vector of the user who is the target of recommendation, according to a content recommendation request received from the device 3200 of the user. For example, a window for selecting the content recommendation request may pop up on the display 3210 of the device 3200 of the user. Alternatively, for example, when the user accesses an application, a webpage, or the like related to content recommendation, the content recommendation request may be automatically transmitted to the server 3100. The behaviors, reactions, and actions related to the preference degrees of the user for the plurality of pieces of content may be transmitted to the server 3100 together with the content recommendation request, and the user feedback vector obtaining module 3131 may obtain the feedback vector of the user who is the target of recommendation, based on the behaviors, reactions, and actions related to the preference degrees of the user for the plurality of pieces of content.

The feedback information obtaining module 3132 may obtain, from the device 3200, behaviors, reactions, and actions related to the preference degrees of the plurality of users for the plurality of pieces of content, and generate or obtain feedback information indicating preference degrees of the plurality of users for at least one of the plurality of pieces of content. In the present specification, the feedback information may include a plurality of feedback vectors indicating the preference degrees of the plurality of users for the plurality of pieces of content, and the feedback vector may be a vector indicating a preference degree of the user for at least one of the plurality of pieces of content.

In detail, the feedback vectors of the plurality of users may be pre-generated and stored in the user feedback vector obtaining module 3131 before the content recommendation request is received. Also, for example, when there is the content recommendation request, the user feedback vector obtaining module 3131 may generate a plurality of feedback vectors based on latest behaviors, reactions, and actions related to the preference degrees of the plurality of users for the plurality of pieces of content.

The embedding vector generation module 3133 may generate user embedding vectors for the plurality of users and content embedding vectors for the plurality of pieces of content, based on the feedback information generated by the user feedback vector obtaining module 3131. The embedding vector generation module 3133 may generate the user embedding vectors for the plurality of users and the content embedding vectors for the plurality of pieces of content, through matrix factorization, training of an artificial neural network model including a specific architecture, or an embedding vector generation method based on one-hot encoding, but an embodiment of the disclosure is not limited thereto.

In detail, the user embedding vectors for the plurality of users and the content embedding vectors for the plurality of pieces of content may be pre-set and stored in the embedding vector generation module 3133, before the content recommendation request is received. Also, for example, when there is the content recommendation request, the embedding vector generation module 3133 may generate the user embedding vectors for the plurality of users and the content embedding vectors for the plurality of pieces of content, based on the latest behaviors, reactions, and actions related to the preference degrees of the plurality of users for the plurality of pieces of content.

The grouping module 3134 may group the plurality of users, based on the user embedding vectors for the plurality of users. In detail, the number of a plurality of user groups may be stored in the grouping module 3134, and the plurality of users may be grouped based on the number of the plurality of user groups and the user embedding vectors for the plurality of users. For example, the grouping module 3134 may determine the plurality of user groups based on Euclidean distances between the user embedding vectors for the plurality of users. Also, for example, the grouping module 3134 may group the plurality of users to a pre-set number of the plurality of user groups based on k-mean clustering. Information about the grouped plurality of users may be stored in the grouping module 3134.

Also, in detail, the user embedding vectors for the plurality of users may be pre-generated before the content recommendation request is received, and the plurality of users may be grouped based on the pre-generated user embedding vectors for the plurality of users. Also, for example, when there is the content recommendation request, the embedding vector generation module 3133 may generate the user embedding vectors for the plurality of users, based on the latest behaviors, reactions, and actions related to the preference degrees of the plurality of users for the plurality of pieces of content, and the grouping module 3134 may group the plurality of users, based on the generated user embedding vectors for the plurality of users.

The central user determination module 3135 may determine central users of the plurality of user groups based on the user embedding vectors for the plurality of users. In detail, the central users of the plurality of user groups may be determined based on Euclidean distances between user embedding vectors for at least one user belonging to each of the determined plurality of user groups. The central user of the plurality of user groups may be stored in the central user determination module 3135.

In detail, when there is the content recommendation request, the central user determination module 3135 may determine the central users of the plurality of user groups based on the latest behaviors, reactions, and actions related to the preference degrees of the plurality of users for the plurality of pieces of content. When the central users of the plurality of user groups are determined based on the latest behaviors, reactions, and actions related to the preference degrees of the plurality of users for the plurality of pieces of content, more appropriate customized recommendation content may be provided because 1) a required time until content is recommended to the user who is the target of recommendation may be increased, but 2) data about the latest behaviors, reactions, and actions related to the preference degrees of the plurality of users for the plurality of pieces of content is used.

The artificial neural network model 3136 may be used to estimate a preference degree of a user for content. Training data of the artificial neural network model 3136 may be the user embedding vectors for the plurality of users and the content embedding vectors for the plurality of pieces of content. The artificial neural network model 3136 may include at least one of a GMF model, an MLP model, or an NeuMF model. Also, the artificial neural network model 3136 may be iteratively trained when the user embedding vectors for the plurality of users and the content embedding vectors for the plurality of pieces of content are generated. Also, for example, after at least one piece of content is recommended to a new user, a user embedding vector of the new user may be used as the training data of the artificial neural network model 3136.

The preference vector obtaining module 3137 may generate preference vectors of the central users, which indicate estimated preference degrees of the central users for the plurality of pieces of content, based on the user embedding vectors for the central users and the content embedding vectors for the plurality of pieces of content, which are input to the artificial neural network model 3136. For example, a preference vector of a first central user may indicate estimated preference degrees of the first central user for the plurality of pieces of content, and when a first element value is greater than a second element value in the preference vector of the first central user, the processor 3120 may estimate that the first central user may prefer first content more than second content.

The recommendation content determination module 3138 may determine at least one piece of recommendation content to be recommended, based on the preference vectors of the central users, which are obtained by the preference vector obtaining module 3137.

In detail, the recommendation content determination module 3138 may select a central user to be used to recommend content based on the preference vectors of the central users and the feedback vector of the user, which is stored in the user feedback vector obtaining module 3131. For example, the central user to be used to recommend content may be selected, based on inner products or difference values between the feedback vector of the user who is the target of recommendation and the preference vectors of the central users, from among the preference vectors. For example, the inner products between the feedback vector of the user and the preference vectors of the central users may be calculated, and a central user having a highest value of the inner product may be selected as the central user to be used to recommend content.

In detail, the preference vector of the selected central user may be extracted from the preference vectors of the central users, and at least one piece of recommendation content to be recommended to the user may be determined. For example, the number of pieces of content to be recommended to the user may be pre-set and stored in the recommendation content determination module 3138. Also, the at least one piece of recommendation content to be recommended to the user may be selected according to the pre-stored number of pieces of content to be recommended to the user, the content having a high value of element in the preference vector of the selected central user.

The user feedback data DB 3139 may store a history or data about the behaviors, reactions, or actions related to the preference degrees of the plurality of users for the plurality of pieces of content. For example, the communication interface 3110 of the server 3100 may receive, from the communication interface 3220 of the device 3200, the history or data about the behaviors, reactions, or actions related to the preference degrees of the plurality of users for the plurality of pieces of content, and the received history or data about the behaviors, reactions, or actions related to the preference degrees of the plurality of users for the plurality of pieces of content may be stored in the user feedback data DB 3139. The feedback information obtaining module 3132 may obtain feedback information by obtaining the history or data about the behaviors, reactions, or actions related to the preference degrees of the plurality of users for the plurality of pieces of content, from the user feedback data DB 3139.

The group number adjustment module 3140 may adjust the number of the plurality of user groups based on the feedback vector of the user who is the target of content recommendation, and the preference vector of the central user selected by the recommendation content determination module 3138.

In detail, the group number adjustment module 3140 may adjust the number of the plurality of user groups, considering a degree of similarity between the feedback vector of the user who is the target of content recommendation, and the preference vector of the central user selected by the recommendation content determination module 3138. For example, the group number adjustment module 3140 may calculate a similarity value between the feedback vector of the user who is the target of content recommendation and the preference vector of the central user selected by the recommendation content determination module 3138, and compare the calculated similarity value with a threshold similarity value pre-stored in the group number adjustment module 3140. When the calculated similarity value is greater than the pre-stored threshold similarity value, the group number adjustment module 3140 may decrease the number of the plurality of user groups, and when the calculated similarity value is less than the pre-stored threshold similarity value, the group number adjustment module 3140 may increase the number of the plurality of user groups.

Also, in detail, the group number adjustment module 3140 may adjust the number of the plurality of user groups by comparing the Euclidean distances between the user embedding vectors for the at least one user belonging to each of the determined plurality of user groups with a pre-set threshold value. For example, for an arbitrary user group from among the plurality of user groups, when a distance in an embedding space between a first user and a second user belonging to the arbitrary user group is equal to or greater than a threshold value, the group number adjustment module 3140 may adjust the number of the plurality of user groups by increasing because it is not appropriate that the first user and the second user belong to a same user group.

According to an embodiment of the disclosure, a method of recommending content to a user may include based on a content recommendation request received from a device of the user. A Method may include obtaining a feedback vector of the user for at least one of a plurality of pieces of content. A Method may include obtaining feedback information for the plurality of pieces of content used by a plurality of users. A Method may include generating user embedding vectors for the plurality of users and content embedding vectors for the plurality of pieces of content, based on the feedback information. A Method may include determining a plurality of user groups and central users of the plurality of user groups by grouping the plurality of users based on the user embedding vectors for the plurality of users. A Method may include inputting user embedding vectors for the central users and the content embedding vectors for the plurality of pieces of content to an artificial neural network model configured to estimate a preference degree for content. A Method may include obtaining preference vectors of the central users, which indicate estimated preference degrees of the central users for the plurality of pieces of content, the preference vectors being output by the artificial neural network model. A Method may include determining at least one piece of recommendation content to be recommended to the user, based on the feedback vector of the user and the preference vectors of the central users. A Method may include recommending the determined at least one piece of recommendation content to the user.

According to an embodiment of the disclosure, the feedback vector of the user may be a vector indicating a preference degree of the user for at least one of the plurality of pieces of content, and the feedback information may include a plurality of feedback vectors indicating preference degrees of the plurality of users for the plurality of pieces of content.

According to an embodiment of the disclosure, the generating of the user embedding vectors for the plurality of users and the content embedding vectors for the plurality of pieces of content may include generating user embedding vectors for the plurality of users and content embedding vectors for the plurality of pieces of content, which include the feedback information and errors equal to or less than a pre-set first threshold value, according to a pre-set standard.

According to an embodiment of the disclosure, the method may include the determining of the plurality of user groups and the central users of the plurality of user groups may include determining the plurality of user groups based on a pre-set number of the plurality of user groups and Euclidean distances between the user embedding vectors for the plurality of users. The method may include determining the central users of the plurality of user groups based on Euclidean distances between user embedding vectors for one user at least one user belonging to each of the determined plurality of user groups.

According to an embodiment of the disclosure, the method may include selecting a central user among the central users, based on the feedback vector of the user and the preference vectors of the central users. The method may include extracting a preference vector of the selected central user from among the preference vectors of the central users, and determining the recommendation content based on the extracted preference vector.

According to an embodiment of the disclosure, the method may further include determining similarity values between preference degrees of the central users for the plurality of pieces of content and a preference degree of the user for the plurality of pieces of content, based on the feedback vector of the user and the preference vectors of the central users. The method may further include adjusting a number of the plurality of user groups based on the determined similarity values.

According to an embodiment of the disclosure, the method may include selecting a central user among the central users, based on the feedback vector of the user and the preference vectors of the central users. The method may include identifying a similarity value of the selected central user from among the determined similarity values. The method may include, based on the identified similarity value being less than or equal to a pre-set second threshold value, increasing the number of the plurality of user groups.

According to an embodiment of the disclosure, the method may include selecting a central user among the central users, based on the feedback vector of the user and the preference vectors of the central users. The method may include identifying a similarity value of the selected central user from among the determined similarity values. The method may include, based on the identified similarity value being greater than or equal to than a pre-set third threshold value, decreasing the number of the plurality of user groups.

According to an embodiment of the disclosure, the method may further include adjusting a number of the plurality of user groups, by comparing Euclidean distances between user embedding vectors for one user at least one user belonging to each of the plurality of user groups with a pre-set fourth threshold value.

According to an embodiment of the disclosure, the artificial neural network model may include at least one of a generalized matrix factorization (GMF) model, a multi-layer perception (MLP) model, or a neural matrix factorization (NeuMF) model.

According to an embodiment of the disclosure, the artificial neural network model may be trained by using, as training data, the user embedding vectors for the plurality of users and the content embedding vectors for the plurality of pieces of content.

According to an embodiment of the disclosure, the method may include generating a user embedding vector for the user based on the feedback information and the feedback vector of the user. The method may include regenerating the user embedding vectors for the plurality of users and the content embedding vectors for the plurality of pieces of content. The method may include regrouping the user and the plurality of users based on the adjusted number of the plurality of user groups.

According to an embodiment of the disclosure, a server for recommending content to a user includes a communication interface, a memory storing one or more instructions and a processor configured to execute the one or more instructions to: based on a content recommendation request received from a device of the user, obtain a feedback vector of the user for at least one of a plurality of pieces of content, obtain feedback information for the plurality of pieces of content used by a plurality of users, generate user embedding vectors for the plurality of users and content embedding vectors for the plurality of pieces of content, based on the feedback information, determine a plurality of user groups and central users of the plurality of user groups by grouping the plurality of users based on the user embedding vectors for the plurality of users, input the user embedding vectors for the central users and the content embedding vectors for the plurality of pieces of content to an artificial neural network model configured to estimate a preference degree of the user for content, obtain preference vectors of the central users, which indicate estimated preference degrees of the central users for the plurality of pieces of content, the preference vectors being output by the artificial neural network model, determine at least one piece of recommendation content to be recommended to the user, based on the feedback vector of the user and the preference vectors of the central users, and recommend the determined at least one piece recommendation content to the user.

According to an embodiment of the disclosure, the processor may be configured to determine the plurality of user groups based on a pre-set number of the plurality of user groups and Euclidean distances between the user embedding vectors for the plurality of users. The processor may be configured to determine the central users of the plurality of user groups based on Euclidean distances between user embedding vectors for one user at least one user belonging to each of the determined plurality of user groups.

According to an embodiment of the disclosure, the processor may be configured to select a central user among the central users, based on the feedback vector of the user and the preference vectors of the central users, extract a preference vector of the selected central user from among the preference vectors of the central users, and determine the recommendation content based on the extracted preference vector.

According to an embodiment of the disclosure, the processor may be configured to determine similarity values between preference degrees of the central users for the plurality of pieces of content and a preference degree of the user for the plurality of pieces of content based on the feedback vector of the user and the preference vectors of the central users. The processor may be configured to determine adjust a number of the plurality of user groups based on the determined similarity values.

According to an embodiment of the disclosure, the processor may be configured to determine adjust a number of the plurality of user groups by comparing Euclidean distances between user embedding vectors for one user at least one user belonging to each of the plurality of user groups with a pre-set fourth threshold value.

According to an embodiment of the disclosure, the artificial neural network model may include at least one of a generalized matrix factorization (GMF) model, a multi-layer perception (MLP) model, or a neural matrix factorization (NeuMF) model.

According to an embodiment of the disclosure, the artificial neural network model may be trained by using, as training data, the user embedding vectors for the plurality of users and the content embedding vectors for the plurality of pieces of content.

According to an embodiment, a non-transitory computer-readable storage medium, having a computer program for learning universal vector representation of concepts in a distributed environment, which implemented on at least one processor, is provided. The processor may be configure to, based on a content recommendation request received from a device of the user, obtain a feedback vector of the user for at least one of a plurality of pieces of content. The processor may be configure to obtain feedback information for the plurality of pieces of content used by a plurality of users. The processor may be configure to generate user embedding vectors for the plurality of users and content embedding vectors for the plurality of pieces of content, based on the feedback information, The processor may be configure to determine a plurality of user groups and central users of the plurality of user groups by grouping the plurality of users based on the user embedding vectors for the plurality of users. The processor may be configure to input the user embedding vectors for the central users and the content embedding vectors for the plurality of pieces of content to an artificial neural network model configured to estimate a preference degree of the user for content. The processor may be configure to obtain preference vectors of the central users, which indicate estimated preference degrees of the central users for the plurality of pieces of content, the preference vectors being output by the artificial neural network model. The processor may be configure to determine at least one piece of recommendation content to be recommended to the user, based on the feedback vector of the user and the preference vectors of the central users. The processor may be configure to recommend the determined at least one piece recommendation content to the user.

According to an embodiment of the disclosure, a machine-readable storage medium or recording medium may be provided in a form of a non-transitory storage medium. Here, the ‘non-transitory storage medium’ only denotes a tangible device and does not contain a signal (for example, electromagnetic waves). This term does not distinguish a case where data is stored in the storage medium semi-permanently and a case where the data is stored in the storage medium temporarily. For example, the ‘non-transitory storage medium’ may include a buffer where data is temporarily stored.

According to an embodiment of the disclosure, a method according to various embodiments of the disclosure disclosed in the present specification may be provided by being included in a computer program product. The computer program products are products that can be traded between sellers and buyers. The computer program product may be distributed in a form of machine-readable storage medium (for example, a compact disc read-only memory (CD-ROM)), or distributed (for example, downloaded or uploaded) through an application store or directly or online between two user devices (for example, smart phones). In the case of online distribution, at least a part of the computer program product (for example, a downloadable application) may be at least temporarily generated or temporarily stored in a machine-readable storage medium, such as an electronic device of a manufacturer, an electronic device of an application store, or a memory of a relay electronic device.

The above description of the disclosure is provided for illustration, and it will be understood by one of ordinary skill in the art that various changes in form and details may be readily made therein without departing from essential features and the scope of the disclosure as defined by the following claims. Accordingly, the embodiments of the disclosure described above are examples in all aspects and are not limited. For example, each component described as a single type may be implemented in a distributed manner, and similarly, components described as distributed may be implemented in a combined form.

The scope of the disclosure is defined by the appended claims rather than the detailed description, and all changes or modifications within the scope of the appended claims and their equivalents will be construed as being included in the scope of the disclosure.

What is claimed is:

1. A method of recommending content to a user, the method comprising:
based on a content recommendation request received from a device of the user, obtaining a feedback vector of the user for at least one of a plurality of pieces of content;
obtaining feedback information for the plurality of pieces of content used by a plurality of users;
generating user embedding vectors for the plurality of users and content embedding vectors for the plurality of pieces of content based on the feedback information;
determining a plurality of user groups and central users of the plurality of user groups by grouping the plurality of users based on the user embedding vectors for the plurality of users;
inputting user embedding vectors for the central users and the content embedding vectors for the plurality of pieces of content to an artificial neural network model configured to estimate a preference degree for content;
obtaining preference vectors of the central users, which indicate estimated preference degrees of the central users for the plurality of pieces of content the preference vectors being output by the artificial neural network model;
determining at least one piece of recommendation content to be recommended to the user, based on the feedback vector of the user and the preference vectors of the central user; and
recommending the determined at least one piece of recommendation content to the user.

2. The method of claim 1, wherein the feedback vector of the user is a vector indicating a preference degree of the user for at least one of the plurality of pieces of content, and
wherein the feedback information comprises a plurality of feedback vectors indicating preference degrees of the plurality of users for the plurality of pieces of content.

3. The method of claim 1, wherein the generating of the user embedding vectors for the plurality of users and the content embedding vectors for the plurality of pieces of content comprises:
generating user embedding vectors for the plurality of users and content embedding vectors for the plurality of pieces of content, which include the feedback information and errors equal to or less than a pre-set first threshold value, according to a pre-set standard.

4. The method of claim 1, wherein the determining of the plurality of user groups and the central users of the plurality of user groups comprises:
determining the plurality of user groups based on a pre-set number of the plurality of user groups and Euclidean distances between the user embedding vectors for the plurality of users; and
determining the central users of the plurality of user groups based on Euclidean distances between user embedding vectors for at least one user belonging to each of the determined plurality of user groups.

5. The method of claim 1, wherein the determining of the at least one piece of recommendation content to be recommended to the user comprises:
selecting a central user among the central users, based on the feedback vector of the user and the preference vectors of the central users;
extracting a preference vector of the selected central user from among the preference vectors of the central users; and
determining the at least one piece of recommendation content based on the extracted preference vector.

6. The method of claim 1, further comprising:
determining similarity values between the estimated preference degrees of the central users for the plurality of pieces of content and a preference degree of the user for the plurality of pieces of content, based on the feedback vector of the user and the preference vectors of the central users; and
adjusting a number of the plurality of user groups based on the determined similarity values.

7. The method of claim 6, wherein the adjusting of the number of the plurality of user groups comprises:
selecting a central user among the central users, based on the feedback vector of the user and the preference vectors of the central users;
identifying a similarity value of the selected central user from among the determined similarity values; and
based on the identified similarity value being less than or equal to a pre-set second threshold value, increasing the number of the plurality of user groups.

8. The method of claim 6, wherein the adjusting of the number of the plurality of user groups comprises:
selecting a central user among the central users, based on the feedback vector of the user and the preference vectors of the central users;
identifying a similarity value of the selected central user from among the determined similarity values; and
based on the identified similarity value being greater than or equal to than a pre-set third threshold value, decreasing the number of the plurality of user groups.

9. The method of claim 1, further comprising adjusting a number of the plurality of user groups, by comparing Euclidean distances between user embedding vectors for at least one user belonging to each of the plurality of user groups with a pre-set fourth threshold value.

10. The method of claim 1, wherein the artificial neural network model comprises at least one of a generalized matrix factorization (GMF) model, a multi-layer perception (MLP) model, or a neural matrix factorization (NeuMF) model.

11. The method of claim 1, wherein the artificial neural network model is trained by using, as training data, the user embedding vectors for the plurality of users and the content embedding vectors for the plurality of pieces of content.

12. The method of claim 6, further comprising:
generating a user embedding vector for the user based on the feedback information and the feedback vector of the user, and regenerating the user embedding vectors for the plurality of users and the content embedding vectors for the plurality of pieces of content; and
regrouping the user and the plurality of users based on the adjusted number of the plurality of user groups.

13. A server for recommending content to a user, the server comprising:
a communication interface;
a memory storing one or more instructions; and
a processor configured to execute the one or more instructions to:
based on a content recommendation request received from a device of the user, obtain a feedback vector of the user for at least one of a plurality of pieces of content,
obtain feedback information for the plurality of pieces of content used by a plurality of users,
generate user embedding vectors for the plurality of users and content embedding vectors for the plurality of pieces of content based on the feedback information,
determine a plurality of user groups and central users of the plurality of user groups by grouping the plurality of users based on the user embedding vectors for the plurality of users,
input user embedding vectors for the central users and the content embedding vectors for the plurality of pieces of content to an artificial neural network model configured to estimate a preference degree for content,
obtain preference vectors of the central users, which indicate estimated preference degrees of the central users for the plurality of pieces of content, the preference vectors being output by the artificial neural network model,
determine at least one piece of recommendation content to be recommended to the user, based on the feedback vector of the user and the preference vectors of the central user, and
recommend the determined at least one piece of recommendation content to the user.

14. The server of claim 13, wherein the processor is further configured to execute the one or more instructions to:
determine the plurality of user groups based on a pre-set number of the plurality of user groups and Euclidean distances between the user embedding vectors for the plurality of users, and
determine the central users of the plurality of user groups based on Euclidean distances between user embedding vectors for at least one user belonging to each of the determined plurality of user groups.

15. The server of claim 13, wherein the processor is further configured to execute the one or more instructions to:
select a central user among the central users, based on the feedback vector of the user and the preference vectors of the central users,
extract a preference vector of the selected central user from among the preference vectors of the central users, and determine the at least one piece of recommendation content based on the extracted preference vector.

16. The server of claim 13, wherein the processor is further configured to execute the one or more instructions to:
determine similarity values between the estimated preference degrees of the central users for the plurality of pieces of content and a preference degree of the user for the plurality of pieces of content based on the feedback vector of the user and the preference vectors of the central users, and
adjust a number of the plurality of user groups based on the determined similarity values.

17. The server of claim 13, wherein the processor is further configured to execute the one or more instructions to adjust a number of the plurality of user groups by comparing Euclidean distances between user embedding vectors for at least one user belonging to each of the plurality of user groups with a pre-set fourth threshold value.

18. The server of claim 13, wherein the artificial neural network model comprises at least one of a generalized matrix factorization (GMF) model, a multi-layer perception (MLP) model, or a neural matrix factorization (NeuMF) model.

19. The server of claim 13, wherein the artificial neural network model is trained by using, as training data, the user embedding vectors for the plurality of users and the content embedding vectors for the plurality of pieces of content.

20. A non-transitory computer-readable recording medium having recorded thereon a program for executing the method of claim 1 on a computer.
